(19) United States
(12) Patent Application Publication
(10) Pub. No.: US 2008/0223409 A1
(43) Pub. Date: Sep. 18, 2008

(54) METHOD AND APPARATUS FOR EXTENDING EQUIPMENT UPTIME IN ION IMPLANTATION

(76) Inventors: Thomas N. Horsky, Boxborough, MA (US); Dennis Manning, Commerce, OK (US); Kevin S. Cook, Hammonds Plains (CA)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 12/105,702

(22) Filed: Apr. 18, 2008

Related U.S. Application Data
(63) Continuation-in-part of application No. 10/582,392, filed on Jun. 28, 2007.
(60) Provisional application No. 60/529,343, filed on Dec. 12, 2003.

(51) Int. Cl. B08B 5/00; B08B 13/00

(52) U.S. Cl. 134/22.1; 134/166 R

(57) ABSTRACT

An in situ cleaning system is disclosed for use with semiconductor processing equipment. In accordance with an important aspect of the invention, the cleaning system provides for dynamic cleaning of the semiconductor processing system by varying the pressure of the cleaning gas over time during a cleaning cycle. In particular, the cleaning gas is applied to the semiconductor processing system in repeated pressure cycles. Each pressure cycle begins with the pressure of the cleaning gas at P_{MIN}. The pressure of the cleaning gas is increased to a maximum pressure P_{MAX} during a fill portion of the pressure cycle and maintained for a dwell time selected to allow the available reactants to generate the desired end products. The pressure in the chamber to be cleaned is then reduced during a vent portion of the pressure cycle to permit venting of the reaction products. As such, each time the chamber to be filled is vented and re-filled, reaction products are removed and new reactants are introduced into the chamber to be cleaned, increasing the effective reaction rate.

### CROSS REFERENCE TO RELATED APPLICATIONS

This application is a continuation-in-part of commonly owned co-pending U.S. patent application Ser. No. 10/582,392, filed on Dec. 9, 2004, entitled “Method and Apparatus for Extending Equipment Uptime in Ion Implantation”, which is a nationalization under 35 USC § 371 of PCT Application No. PCT/US04/41525, filed on Dec. 9, 2004, which claims priority to and the benefit of U.S. Provisional Application No. 60/529,343, filed on Dec. 12, 2003. all hereby incorporated by reference.

### BACKGROUND OF THE INVENTION

1. Field of the Invention

The present invention relates to in situ cleaning system for use with semiconductor processing equipment and more particularly to an in situ cleaning system with improved cleaning efficacy in which the pressure of the cleaning gas within the semiconductor processing system to be cleaned is dynamically varied.

2.0 Description of the Prior Art

Ion beams are produced from ions extracted from an ion source. An ion source typically employs an ionization chamber connected to a high voltage power supply. The ionization chamber is associated with a source of ionizing energy, such as an arc discharge, energetic electrons from an electron-emitting cathode, or a radio frequency or microwave antenna, for example. A source of desired ion species is introduced into the ionization chamber as a feed material in gaseous or vaporized form where it is exposed to the ionizing energy. Extraction of resultant ions from the chamber through an extraction aperture is based on the electric charge of the ions. An extraction electrode is situated outside of the ionization chamber, aligned with the extraction aperture, and at a voltage below that of the ionization chamber. The electrode draws the ions out, typically forming an ion beam. Depending upon desired use, the beam of ions may be mass-analyzed for establishing mass and energy purity, accelerated, focused and subjected to scanning forces. The beam is then transported to its point of use, for example into a processing chamber. As the result of the precise energy qualities of the ion beam, its ions may be implanted with high accuracy at desired depth into semiconductor substrates.

Alternatively, the semiconductor substrate may be held on a stage which is wholly enclosed within a plasma-forming processing chamber. A negative voltage is applied to the substrate stage, causing positive ions to be attracted to and subsequently implanted into the substrate. This technology is sometimes referred to as Plasma Doping (PLAD), or Plasma Immersion Ion Implantation (PIII).

The precise qualities of the ion beam, or of the plasma forming chamber in the case of PLAD or PIII, can be severely affected by condensation and deposit of the feed material or of its decomposition products on surfaces of the ion beam-producing system, and in particular surfaces that affect ionization, ion extraction and acceleration. Also, if the deposits are loosely adhered to those surfaces, there is a risk that particles will be formed which are deleterious to device yield if they propagate to the surface of the substrate.

### Ion Contamination

In general, ion beams of N-type dopants, such as P or As, should not contain any significant portion of P-type dopant ions, and ion beams of P-type dopants, such as B or In, should not contain any significant portion of N-type dopant ions. Otherwise a condition known as “cross-contamination” exists and is undesirable. Cross-contamination can occur when source feed materials accumulate in the ion source, and the source feed material is then changed, for example, when first running elemental phosphorus feed material to generate an N-type P⁺ beam, and then switching to BF₃ gas to generate a P-type BF₂⁺ beam.

A serious contamination effect occurs when feed materials accumulate within the ion source so that they interfere with the successful operation of the source. Such a condition invariably has called for removal of the ion source and the extraction electrode for cleaning or replacement, resulting in an extended “down” time of the entire ion implantation system, and consequent loss of productivity.

Many ion sources used in ion implanters for device wafer manufacturing are “hot” sources, that is, they operate by sustaining an arc discharge and generating a dense plasma; the ionization chamber of such a “hot” source can reach an operating temperature of 800 C. or higher, in many cases substantially reducing the accumulation of solid deposits. In addition, the use of BF in such sources to generate boron-containing ion beams further reduces deposits, since in the generation of a BF₃ plasma, copious amounts of fluorine ions are generated; fluorine can etch the walls of the ion source, and in particular, recover deposited boron through the chemical production of gaseous BF₃. With other feed materials, however, detrimental deposits have formed in hot ion sources. Examples include antimony (Sb) metal and solid indium (In), the ions of which are used for doping silicon substrates.

Cold ion sources, for example, the RF bucket-type ion source which uses an immersed RF antenna to excite the source plasma (see, for example, Leung et al., U.S. Pat. No. 6,094,012, herein incorporated by reference), are used in applications where either the design of the ion source includes permanent magnets which must be kept below their Curie temperature, or the ion source is designed to use thermally-sensitive feed materials which break down if exposed to hot surfaces, or where both of these conditions exist. Cold ion sources suffer more from the deposition of feed materials than do hot sources. The use of halogenated feed materials for producing dopants may help reduce deposits to some extent, however, in certain cases, non-halogen feed materials, such as hydrides are preferred over halogenated compounds. For non-halogen applications, ion source feed materials such as gaseous B₂H₆, AsH₃, and PH₃ are used. In some cases, elemental As and P are used, in vaporized form. The use of these gases and vapors in cold ion sources has resulted in significant materials deposition and has required the ion source to be removed and cleaned, sometimes frequently. Cold ion sources which use B₂H₆ and PH₃ are in common use today in FPD implantation tools. These ion sources suffer from cross-contamination (between N- and P-type dopants) and also from particle formation due to the presence of deposits. When transported to the substrate, particles negatively impact yield. Cross-contamination effects have historically forced FPD manufacturers to use dedicated ion implanters, one for N-type ions, and one for P-type ions, which has severely affected cost of ownership.

### Borohydrides

Borohydride materials such as B₁₀H₁₄ (decaborane) and B₁₈H₂₂ (octadecaborane) have attracted interest as ion implantation source materials. Under the right conditions, these materials form the ions B₁₀Hₓ⁺, B₁₀Hₓ⁻, B₁₈Hₓ⁺, and B₁₈Hₓ−. When implanted, these ions enable very shallow, high dose P-type implants for shallow junction formation in CMOS manufacturing. Since these materials are solid at room temperature, they must be vaporized and the vapor introduced into the ion source for ionization. They are low-temperature materials (e.g., decaborane melts at 100 C., and has a vapor pressure of approximately 0.2 Torr at room temperature; also, decaborane dissociates above 350 C.), and hence must be used in a cold ion source. They are fragile molecules which are easily dissociated, for example, in hot plasma sources.

### Contamination Issues of Borohydrides

Boron hydrides, such as decaborane and octadecaborane, present a severe deposition problem when used to produce ion beams, due to their propensity for readily dissociating within the ion source. Use of these materials in Bernas-style arc discharge ion sources and also in electron-impact (“soft”) ionization sources, have confirmed that boron-containing deposits accumulate within the ion sources at a substantial rate. Indeed, up to half of the borohydride vapor introduced into the source may stay in the ion source as dissociated, condensed material. Eventually, depending on the design of the ion source, the buildup of condensed material interferes with the operation of the source and necessitates removal and cleaning of the ion source.

Contamination of the extraction electrode has also been a problem when using these materials. Both direct ion beam strike and condensed vapor can form layers that degrade operation of the ion beam formation optics, since these boron-containing layers appear to be electrically insulating. Once an electrically insulating layer is deposited, it accumulates electrical charge and creates vacuum discharges, or so-called “glitches”, upon breakdown. Such instabilities affect the precision quality of the ion beam and can contribute to the creation of contaminating particles.

Cleaning techniques and apparatus for cleaning deposits from semiconductor processing equipment are generally known in the art. Examples of such systems are disclosed, for example, in U.S. Pat. Nos. 5,129,958; 5,354,698; 5,554,854; and 5,940,724. Such techniques normally involve using reactive halogen gases, such as fluorine F or chlorine Cl, which are ionized by a remote plasma source. These halogen ions are introduced into the semiconductor processing equipment to clean undesirable deposits on the surfaces of the semiconductor processing equipment by etching. The reactant products are vented from the semiconductor processing equipment. The semiconductor processing equipment may also be purged, for example, with an inert gas, such as Argon (Ar).

In situ cleaning systems for semiconductor processing equipment are known in the art. Such in situ cleaning systems are normally located adjacent the semiconductor processing equipment and connected thereto by way of shut-off valves. Such in situ cleaning systems normally include a plasma generator as well as a source of a cleaning gas, such as a halogen cleaning gas. In a normal operating mode, in the case of ion implantation equipment, feed gasses or feed vapors are normally in fluid communication with an ionization chamber. During a cleaning mode of operation, the feed gasses and feed vapor fluid communication paths are normally isolated from the ionization chamber, for example, by way of a shut-off valve. As mentioned above, the cleaning gas is normally isolated from the semiconductor processing equipment by way of isolation valves during a normal mode of operation of the semiconductor processing system.

In a cleaning mode of operation, the shut-off valves are opened to allow the cleaning gas to clean the semiconductor processing equipment. In the case of ion implantation equipment, opening of the cleaning gas shut-off valves allows the ionized cleaning gas to enter the ionization chamber for the cleaning cycle. In known in situ cleaning systems, such as the in situ cleaning system disclosed in US Patent Application Publication No. US 2007/0210260, published on Sep. 13, 2007 and assigned to the same assignee as the present invention, the cleaning cycle is determined by an endpoint detector, such as a residual gas analyzer, which monitors the effluent gases during a cleaning cycle and determines when the partial pressure of a reaction product falls below a predetermined value.

As set forth in US Patent Application Publication No. US 2005/0260354 A1, entitled “In-Situ Process Chamber Preparation Methods for Plasma Ion Implantation Systems” (“the '354 publication”), one known problem with such cleaning systems for use with semiconductor processing equipment is the efficacy of such systems. In particular, the '354 publication suggests that the cleaning action can be enhanced by providing thermal energy to the surfaces to be cleaned or by increasing the energy of the ionized cleaning gas by way of an electric field between the surface being cleaned and the plasma while a static pressure in the ionization chamber is maintained between about 1 millitorr and 10 torr. In addition, the method disclosed in the '354 publication includes depositing certain materials on the walls of the chamber to limit contamination to the wafer.

U.S. Pat. No. 6,135,128 discloses a cleaning system for an ion implanter which provides a mechanism for running the cleaning gas simultaneously with the source gas. However, the effect of running the cleaning gas with the source gas on the ion beam characteristics is problematic. One problem is the dilution of the desired dopant in the ion beam, reducing implanted dose rate on the wafer and wafer throughput. A second problem is that the cleaning is not a well-controlled process for removing specific deposits, and may etch away beam line components which do not require deposit removal.

Thus, there is a need for an improved controlled cleaning technique for semiconductor processing systems which provides enhanced cleaning efficacy which is relatively less complex and less expensive than the known systems.

### SUMMARY OF THE INVENTION

Briefly the present invention relates to a cleaning system, for example, an in situ cleaning system for use with semiconductor processing equipment. In accordance with an important aspect of the invention, the cleaning system provides for dynamic cleaning of the semiconductor processing system by varying the pressure of the cleaning gas over time during a cleaning cycle. In one embodiment of the invention, the cleaning gas is applied to the semiconductor processing system in repeated pressure cycles. Each pressure cycle begins with the pressure of the cleaning gas at P_{MIN}. The pressure of the cleaning gas is increased to a maximum pressure P_{MAX} during a fill portion of the pressure cycle and maintained for a dwell time selected to allow the available reactants to generate the desired end products. The pressure in the chamber to be cleaned is then reduced during a vent portion of the pressure cycle to permit venting of the reaction products. As such, each time the chamber to be filled is vented and re-filled, reaction products are removed and new reactants are introduced into the chamber to be cleaned, effectively increasing the effective reaction rate.

### BRIEF DESCRIPTION OF THE DRAWINGS

FIG. 1: Ion beam generation system incorporating reactive gas cleaning.

FIG. 2: Second embodiment of ion beam generation system incorporating reactive gas cleaning.

FIG. 3: Ion beam generation system similar to FIG. 1 but incorporating a vaporizer and certain gas distribution elements.

FIG. 4: Ion beam generation system similar to FIG. 2 but incorporating a vaporizer and certain gas distribution elements.

FIG. 5: Ion generation system incorporating reactive gas cleaning by the introduction of ClF.sub.3.

FIG. 6: Gas box for an ion implanter which includes a reactive gas plasma source, feed vapor source, ion source electronics, and facilities for the plasma source.

FIG. 6A: View similar to FIG. 6, showing a vapor flow control system.

FIG. 6B: Valve schematic for an ion beam generating system.

FIG. 7: Electron-impact ion source.

FIG. 7A: Magnified view of a portion of FIG. 7, showing shielding of elements.

FIG. 7B: Control diagram for an embodiment.

FIG. 8: Ion extraction electrode.

FIG. 9: Ion extraction electrode optics.

FIG. 9a: B.sub.18H.sub.x.sup.+ beam profiles.

FIG. 10: Extraction electrode and manipulator.

FIG. 11: Electrode head-exploded view.

FIG. 12: Second embodiment of electrode head.

FIG. 13: B.sub.10H.sub.x.sup.+ beam current versus decaborane flow rate.

FIG. 14: Lifetime versus decaborane vapor flow rate.

FIG. 15: Etch rate of Si coupon.

FIG. 16: Ion implanter.

FIG. 17 is a representation of an idealized Fill/Vent Characteristic for a variable cleaning gas pressure cycle in accordance with the present invention.

FIG. 18 is a representation of an exemplary pressure cycle for the cleaning gas in accordance with the present invention.

FIG. 19 is an exemplary embodiment of an ion beam generation system incorporating reactive gas cleaning that is configured to provide a variable cleaning gas pressure cycle.

FIG. 20 is an alternate embodiment of the system illustrated in FIG. 19.

FIGS. 21a-21c illustrate one embodiment of the invention in which one or both of the cleaning gas flow rate and system pumping speed can be varied to generate a desired pressure shape characteristic.

FIG. 22 shows actual pressure data during cleaning of a substrate, using the method illustrated in FIGS. 21a-21c. In this embodiment, the flow rate of the NF3 cleaning gas was maintained at a constant level while the pumping speed was alternated between two values.

### DETAILED DESCRIPTION

The present invention relates to a cleaning system, for example, an in situ cleaning system for use with semiconductor processing equipment. In accordance with an important aspect of the invention, the cleaning system provides for dynamic cleaning of the semiconductor processing system by varying the pressure of the cleaning gas over time to create pressure gradients during a cleaning cycle. In particular, in a preferred embodiment the pressure of the cleaning gas is increased to a maximum pressure P_{MAX} to fill the chamber to be cleaned with the cleaning gas. The maximum pressure P_{MAX} is maintained for a dwell time selected to allow the available reactants to generate the desired end products. The pressure in the chamber to be cleaned is then reduced to create pressure gradients to cause the cleaning gas to reach areas which did not get sufficient gas or were not impinged by the cleaning gas and to permit venting of the reaction products. As such, each time the chamber to be filled is vented and re-filled, reaction products are removed and new reactants are introduced into the chamber to be cleaned, effectively increasing the effective reaction rate.

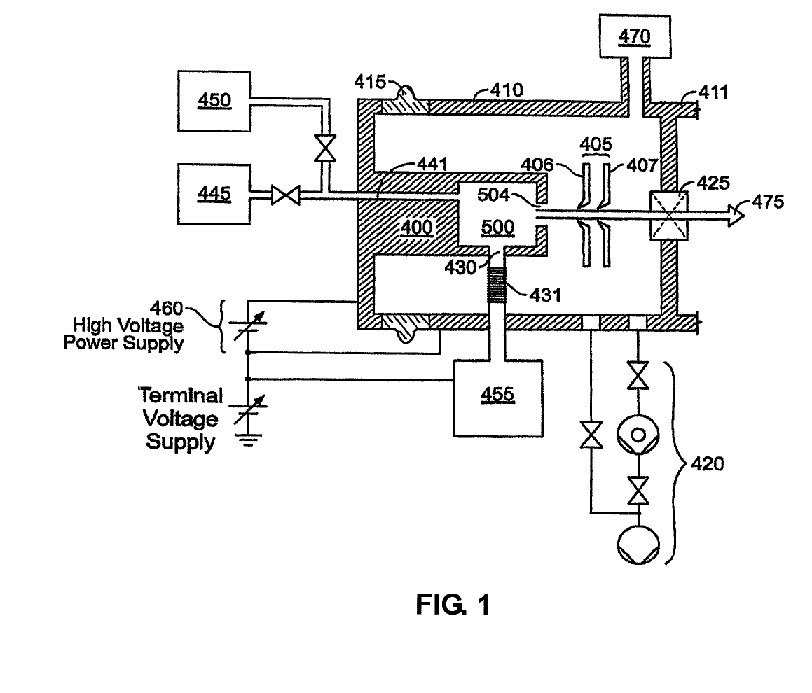

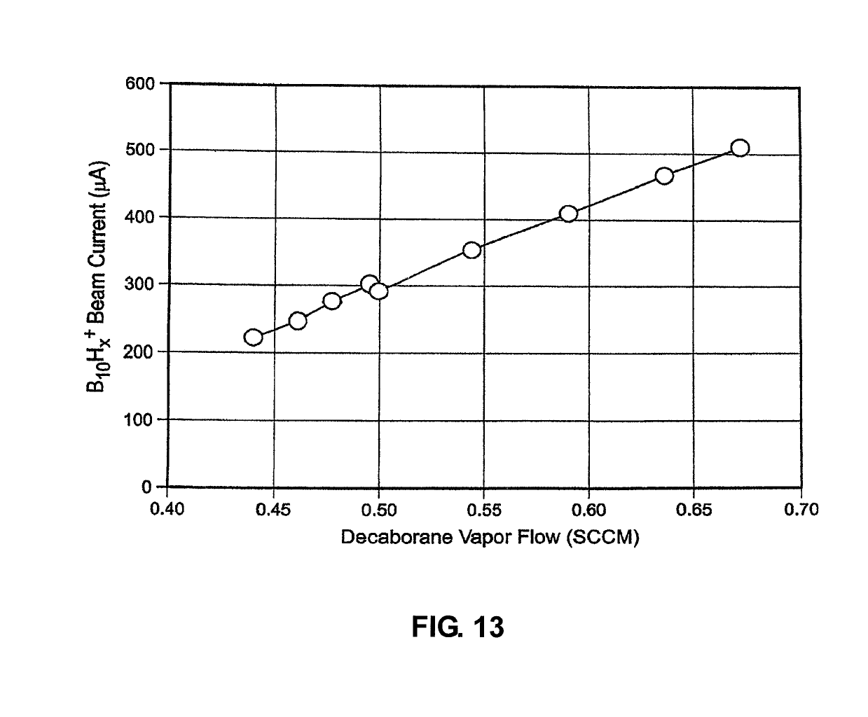

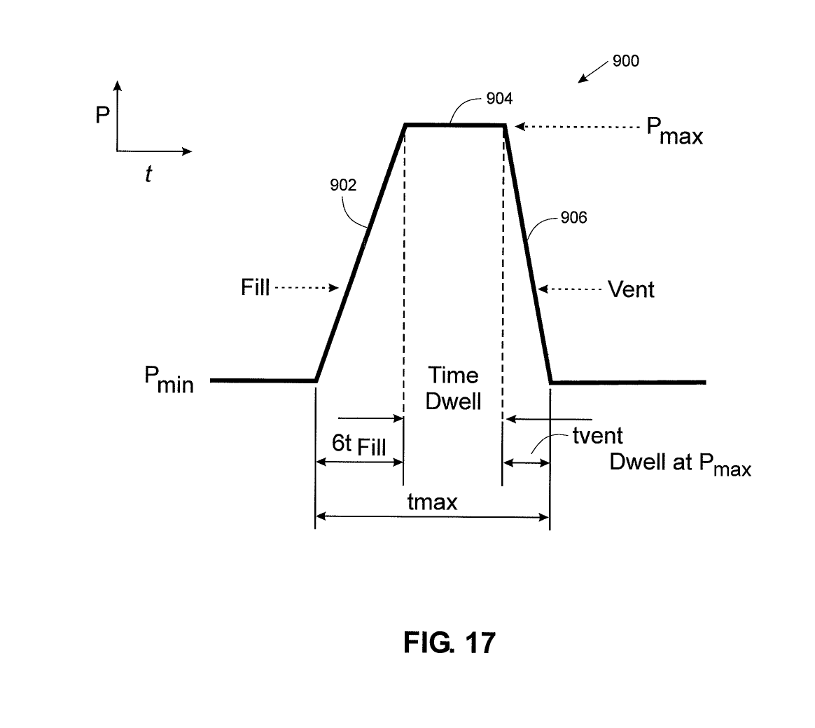

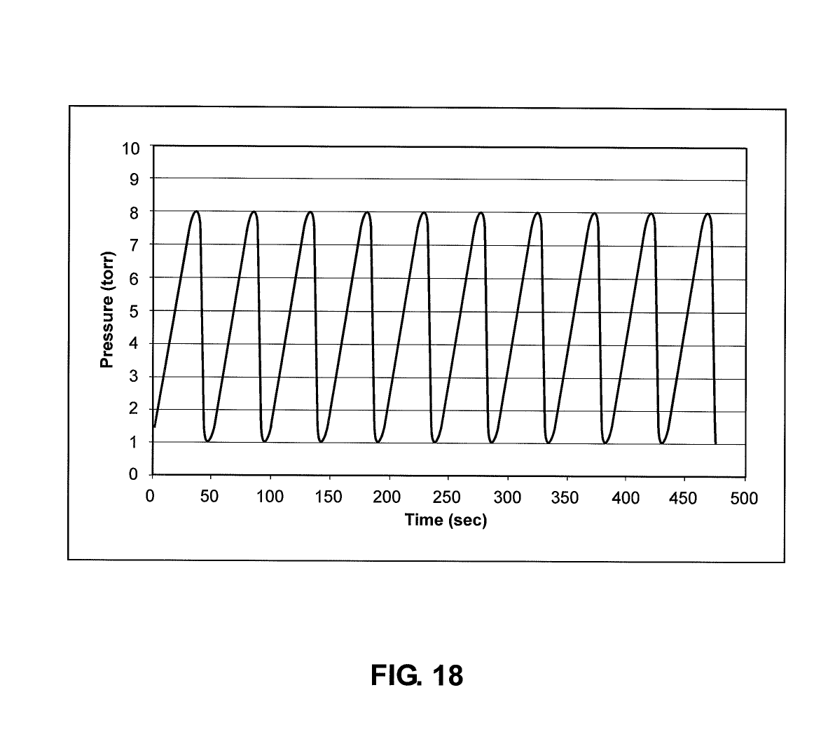

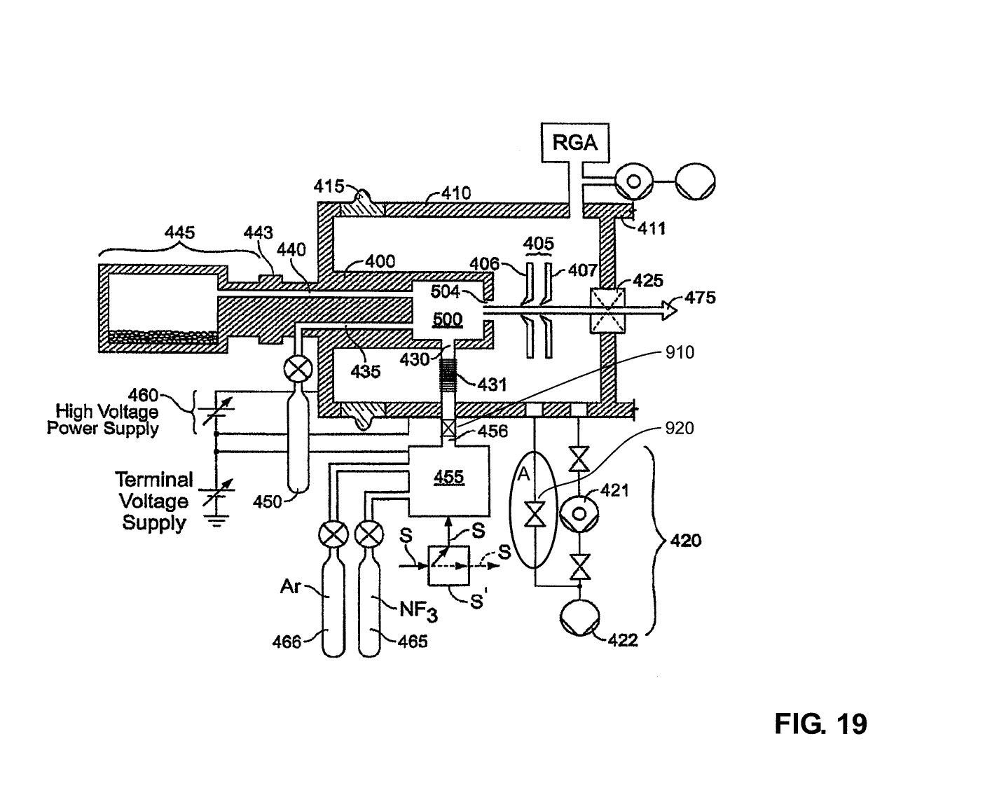

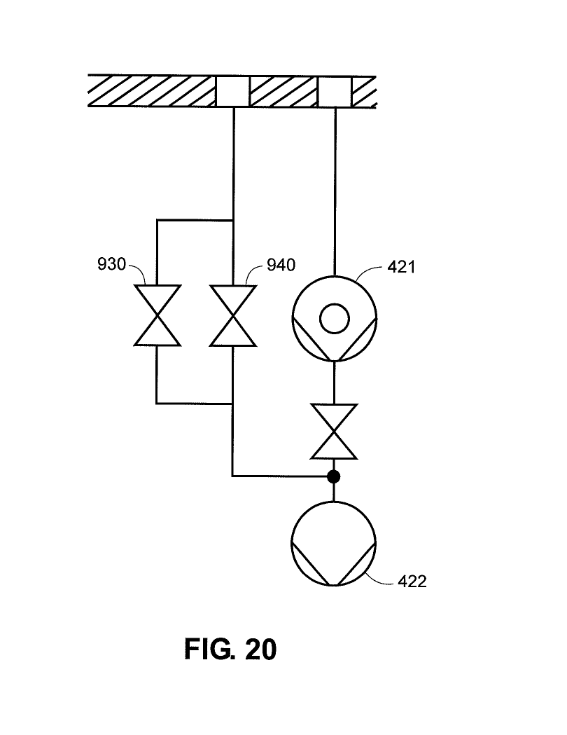

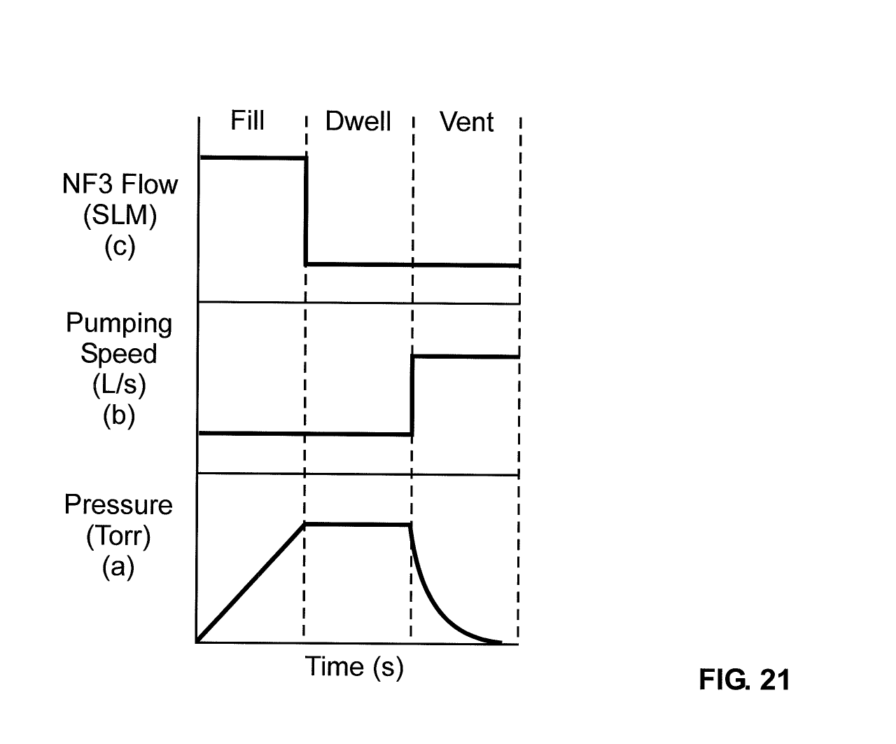

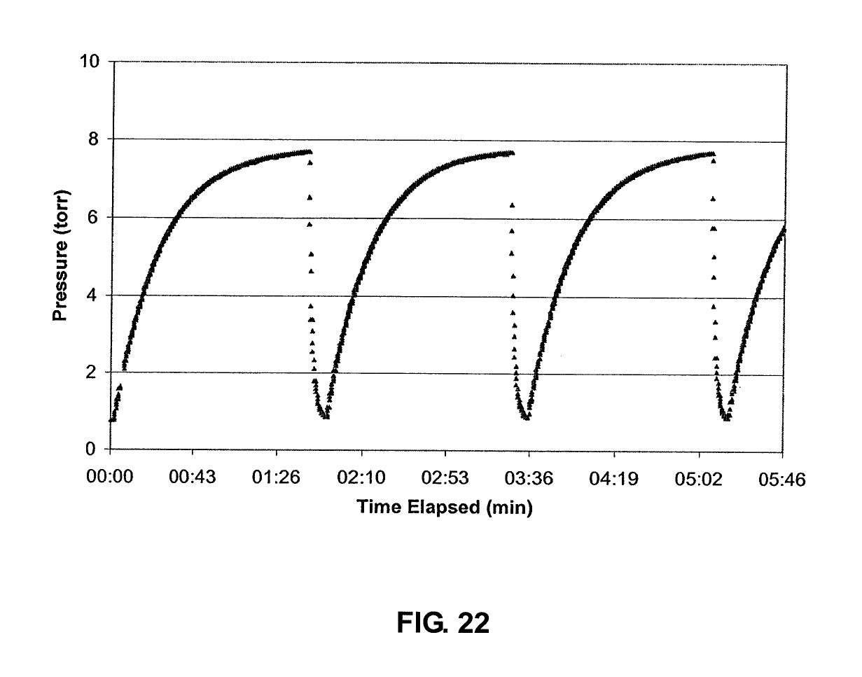

FIGS. 1-16 illustrate an exemplary ion source and an in-situ cleaning system, for example, as described and illustrated in US Patent Application Publication No. US 2007/0210260 A1, assigned to the same assignee as the present invention, hereby incorporated by reference. The present invention is illustrated in FIGS. 17-22 and described below. More specifically, the general concept of the present invention is illustrated in FIG. 17. An exemplary pressure cycle in accordance with the present invention for the cleaning gas is illustrated in FIG. 18. FIGS. 19 and 20 illustrate exemplary hardware embodiments for the present invention. FIGS. 21a-21c illustrate an embodiment in which one or both of the cleaning gas flow rate and system pumping speed can be varied to generate a desired pressure shape characteristic. FIG. 22 shows actual pressure data during cleaning of a substrate, using the method of FIG. 21. In this embodiment, the flow rate of the NF3 cleaning gas was maintained at a constant level while the pumping speed was alternated between two values.

### Ion Beam-Generating System

FIG. 1 shows an ion beam-generating system. As shown in this example, it is adapted to produce an ion beam for transport to an ion implantation chamber for implant into semiconductor wafers or flat-panel displays. Shown are ion source 400, extraction electrode 405, vacuum housing 410, voltage isolation bushing 415 of electrically insulative material, vacuum pumping system 420, vacuum housing isolation valve 425, reactive gas inlet 430, feed gas and vapor-inlet 441, vapor source 445, feed gas source 450, reactive gas source 455, ion source high voltage power supply 460, and resultant ion beam 475. An ion beam transport housing is indicated at 411. The ion source 400 is constructed to provide cluster ions and molecular ions, for example the borohydride ions B₁₀Hₓ⁺, B₁₀Hₓ⁻, B₁₈Hₓ⁺, and B₁₈Hₓ⁻ or, or in addition, more conventional ion beams such as P⁺, As⁺, B⁺, In⁺, Sb⁺, Si⁺, and Ge⁺. Ion source 400 may be a Bernas-style arc-discharge ion source, which is most commonly used for ion implantation, or a “bucket”-type water-cooled ion source which uses an immersed RF (radio frequency) antenna forming an RF field to create ions, a microwave ion source, or an electron-impact ionization source, for example. The gas and vapor inlet 441 for gaseous state feed material to be ionized is connected to a suitable vapor source 445, which may be in close proximity to gas and vapor inlet 441 or may be located in a more remote location, such as in a gas distribution box located elsewhere within a terminal enclosure. A terminal enclosure is a metal box, not shown, which encloses the ion beam generating system. It contains required facilities for the ion source such as pumping systems, power distribution, gas distribution, and controls. When mass analysis is employed for selection of an ion species in the beam, the mass analyzing system may also be located in the terminal enclosure.

In order to extract ions of a well-defined energy, the ion source 400 is held at a high positive voltage (in the more common case where a positively-charged ion beam is generated), with respect to the extraction electrode 405 and vacuum housing 410, by high voltage power supply 460. The extraction electrode 405 is disposed close to and aligned with the extraction aperture 504 of the ionization chamber. It consists of at least two aperture-containing electrode plates, a so-called suppression electrode 406 closest to ionization chamber 500, and a “ground” electrode 407. The suppression electrode 406 is biased negative with respect to ground electrode 407 to reject or suppress unwanted electrons which are attracted to the positively-biased ion source 400 when generating positively-charged ion beams. The ground electrode 407, vacuum housing 410, and terminal enclosure (not shown) are all at the so-called terminal potential, which is at earth ground unless it is desirable to float the entire terminal above ground, as is the case for certain implantation systems, for example for medium-current ion implanters. The extraction electrode 405 may be of the novel temperature-controlled metallic design, described below. If a negatively charged ion beam is generated the ion source is held at an elevated negative voltage with other suitable changes, the terminal enclosure typically remaining at ground.

FIG. 1 shows the reactive gas source 455 at terminal potential, with reactive gas inlet 430 incorporating a high voltage break 431, which can be fabricated of an insulating ceramic such as Al₂O₃, for example. Since ion sources for ion implantation can in general be biased up to a maximum voltage of about 90 kV, this high voltage break 431 must stand off 90 kV for that application. As will be described below, the cleaning system is used only with the ionizing source and high voltages off (de-energized), so that there is only high voltage across break 431 when the vacuum housing 410 is under high vacuum, which makes high voltage standoff clearance requirements easier to meet. A dedicated endpoint detector 470, in communication with the vacuum housing 410, is used to monitor the reactive gas products during chemical cleaning.

For ion sources suitable for use with ion implantation systems, e.g. for doping semiconductor wafers, the ionization chamber is small, having a volume less than about 100 ml, has an internal surface area of less than about 200 cm², and is constructed to receive a flow of the reactive gas, e.g. atomic fluorine or a reactive fluorine-containing compound at a flow rate of less than about 200 Standard Liters Per Minute.

It is seen that the system of FIG. 1 enables in situ cleaning, i.e. without the ion source being removed from its operating position in the vacuum housing, and with little interruption of service.

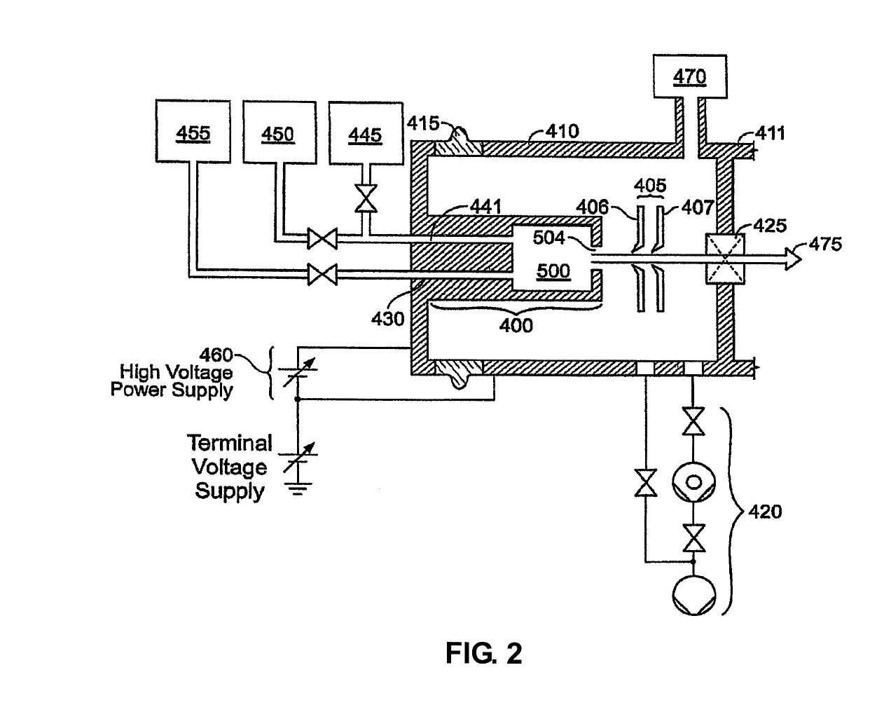

FIG. 2 illustrates another embodiment. The principal difference in FIG. 2 over FIG. 1 is that the reactive gas source 455 and reactive gas inlet 430 are at ion source potential. The benefits of this approach are twofold: it is a more compact arrangement, and it allows the reactive gas source 455 and its associated gas supplies to be contained in the gas box which, at ion source potential supplies gas and power to the ion source 400, as is typical in commercial ion implantation systems.

### Chemical Cleaning System in General

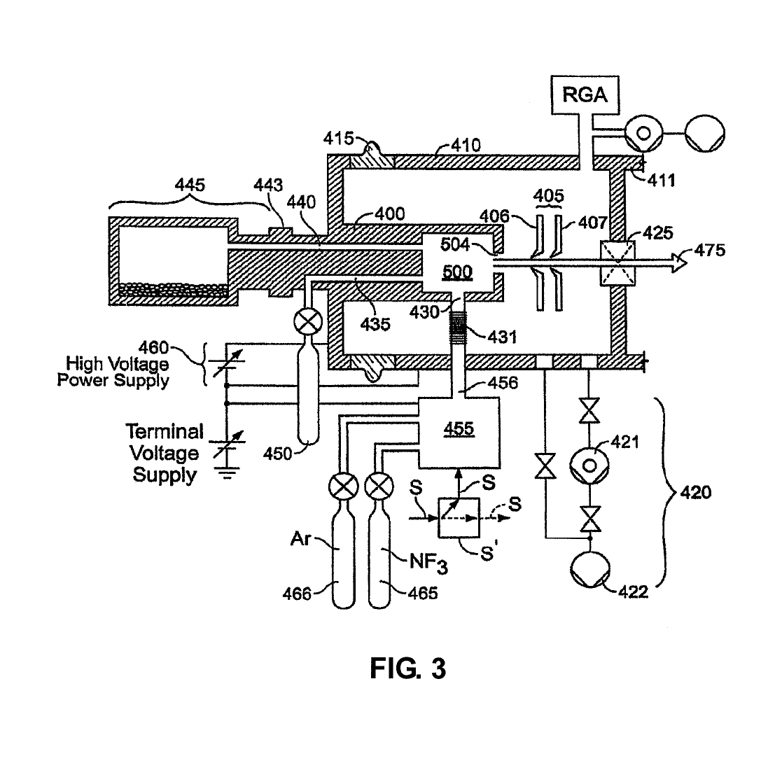

The embodiment of FIG. 3, having many features similar to FIG. 1, is constructed to generate, selectively, both cluster ions and monomer ions. It has a dedicated gas inlet 435 for feed material in normally gaseous state and is in communication, through valve 443, with a vapor source 445 for producing borohydride and other vaporized feed materials. For conducting in-situ chemical cleaning of the ion source and electrode, a remote plasma source 455 disassociates gas supplied by a cleaning gas supply 465, for example NF₃, into decomposition products such as F, F₂, and N-containing compounds. When cleaning is desired, after de-energizing the ion source, the decomposition products are fed into the ionization chamber from the outlet 456 of the remote plasma source 455 by dedicated reactive gas inlet 430. The remote plasma source 455 is mounted on the terminal potential side of voltage isolation bushing 415. Since the ion source 400 runs at high voltage, a high voltage break 431 in vacuum provides voltage isolation.

To initiate a cleaning cycle, the ion source is shut down and vacuum housing isolation valve 425 is closed; the high vacuum pump 421 of the vacuum pumping system 420 is isolated and the vacuum housing 410 is put into a rough vacuum state of <1 Torr by the introduction of dry N₂ gas while the housing is actively pumped by backing pump 422. Once under rough vacuum, argon gas (from Ar gas source 466) is introduced into the plasma source 455 and the plasma source is energized by on-board circuitry which couples radio-frequency (RF) power into the plasma source 455. Once a plasma discharge is initiated, Ar flow is reduced and the F-containing cleaning gas feed 465, e.g. NF₃, is introduced into plasma source 455. Reactive F gas, in neutral form, and other by-products of disassociated cleaning gas feed 465, are introduced through reactive gas inlet 430 into the de-energized ionization chamber 500 of ion source 400. The flow rates of Ar and NF₃ (for example) are high, between 0.1 SLM (Standard Liters per Minute) and a few SLM. Thus, up to about 1 SLM of reactive F as a dissociation product can be introduced into the ion source 400 in this way. Because of the small volume and surface area of ionization chamber 500, this results in very high etch rates for deposited materials. The ionization chamber 500 has a front plate facing the extraction electrode, containing the extraction aperture 504 of cross sectional area between about 0.2 cm² and 2 cm², through which, during energized operation, ions are extracted by extraction electrode 405. During cleaning, the reactive gas load is drawn from ionization chamber 500 through the aperture 504 by vacuum of housing 410; from housing 410 the gas load is pumped by roughing pump 422. Since the extraction electrode 405 is near and faces aperture 504 of ionization chamber 500, the electrode surfaces intercept a considerable volume of the reactive gas flow. This results in an electrode cleaning action, removing deposits from the electrode surfaces, especially from the front surface of suppression electrode 406, which is in position to have received the largest deposits. Thus, it is beneficial to fabricate extraction electrode and its mounting of F-resistant materials, such as Al and Al₂O₃.

The embodiment of FIG. 3 also has an endpoint detector consisting of a differentially-pumped, Residual Gas Analyzer (RGA), constructed for corrosive service. Analyzer RGA is in communication with vacuum housing 410. It is to be used as a detector for the end point of the cleaning action by monitoring partial pressures of F-containing reaction products (for example, BF₃ gas resulting from B combining with F). Other types of endpoint detectors can be used, the RGA being shown to illustrate one particular embodiment. When the boron-containing partial pressures decline at RGA, the cleaning process is largely completed. Once the cleaning process is ended, the plasma source 455 is turned off and is briefly purged with Ar gas (which also purges the ionization chamber 500, the housing 410 and elements contained therein). The roughing pump 422 is then isolated from direct communication with vacuum housing 410, the high vacuum pump 421 isolation valve is opened, and vacuum housing 410 is restored to high vacuum (about 1.times.10−⁵ Torr or below). Then, vacuum housing isolation valve 425 is opened. The system is now ready to resume ion beam generation. The ion source voltage supply 460 can be energized and ion source 400 operated normally.

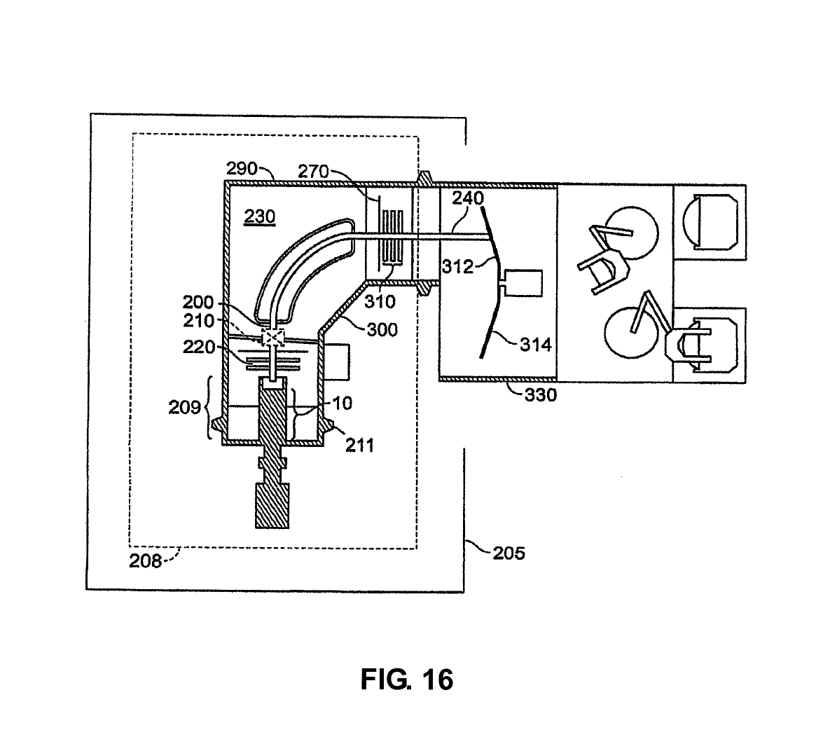

An advantage of the embodiment of FIG. 3 is that the service facilities needed to support the remote plasma source 455, such as cooling water circulation and electrical power, can be at the terminal potential of an ion implanter (see 208 in FIG. 16). This enables sharing facilities denoted at S such as cooling water and electrical power, with the mass-analyzer magnet 230 of the implanter. During cleaning mode, when plasma source 455 is energized, the analyzer 230 is de-energized and therefore does not need water or power, and vise versa, during ion beam production mode. This “sharing” can be accomplished by suitable control arrangements represented diagrammatically at S′, which direct service facilities such as cooling water circulation and power supply connection alternatively to the analyzer magnet 230, dashed arrow S, or to the remote plasma source 455, solid arrow S, depending upon the mode of operation being employed.

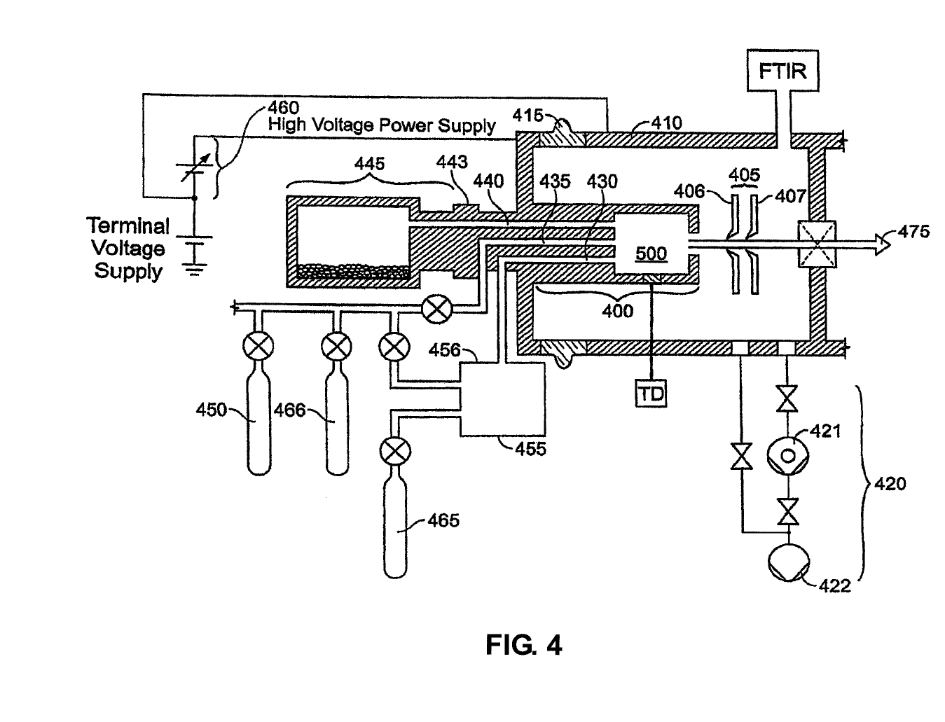

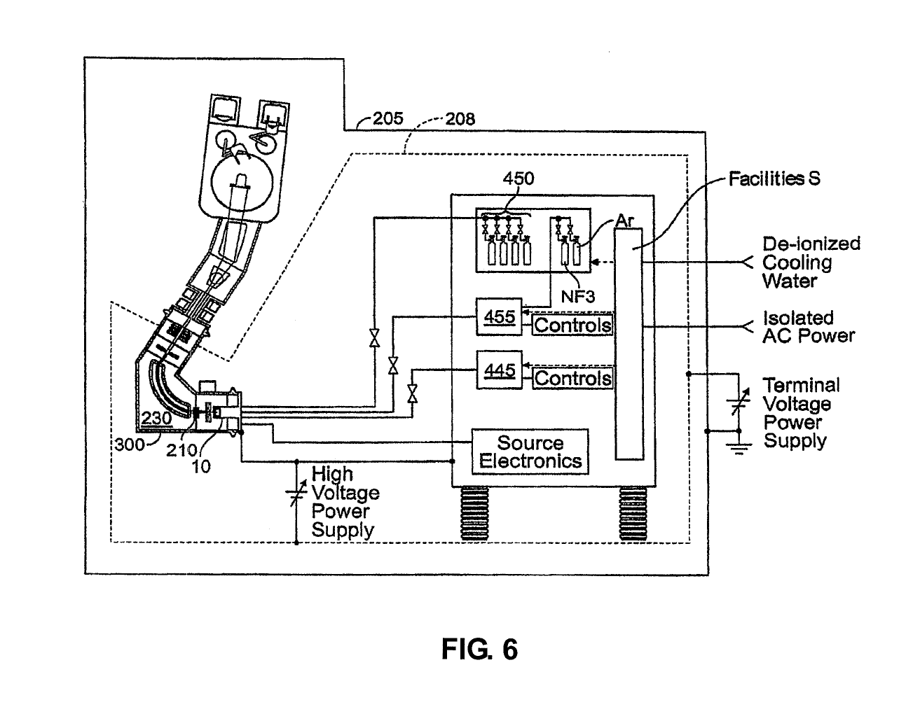

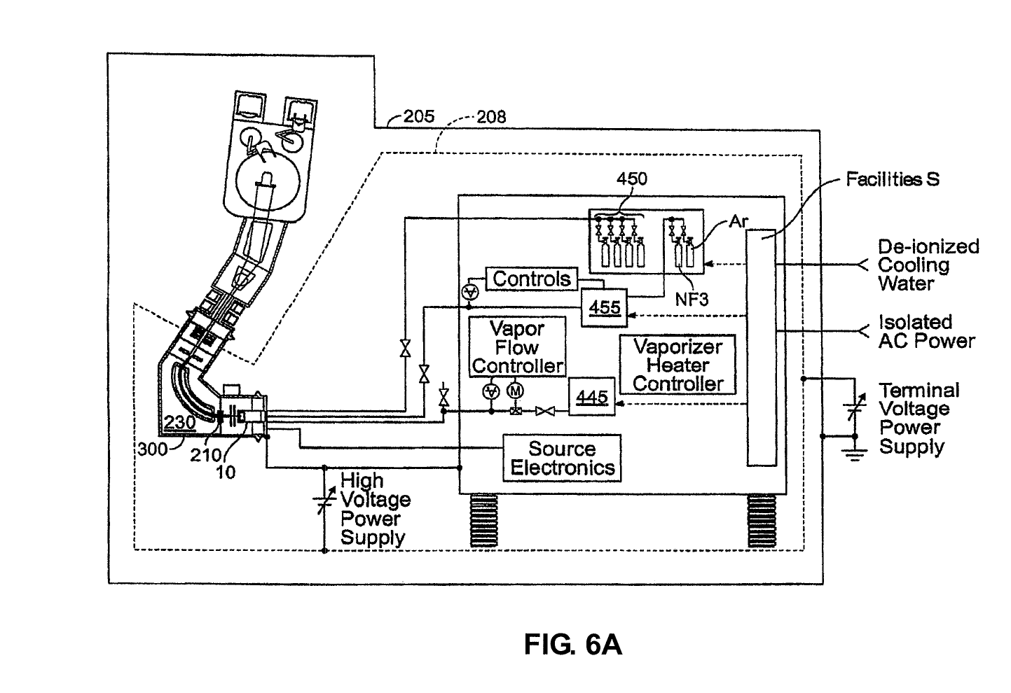

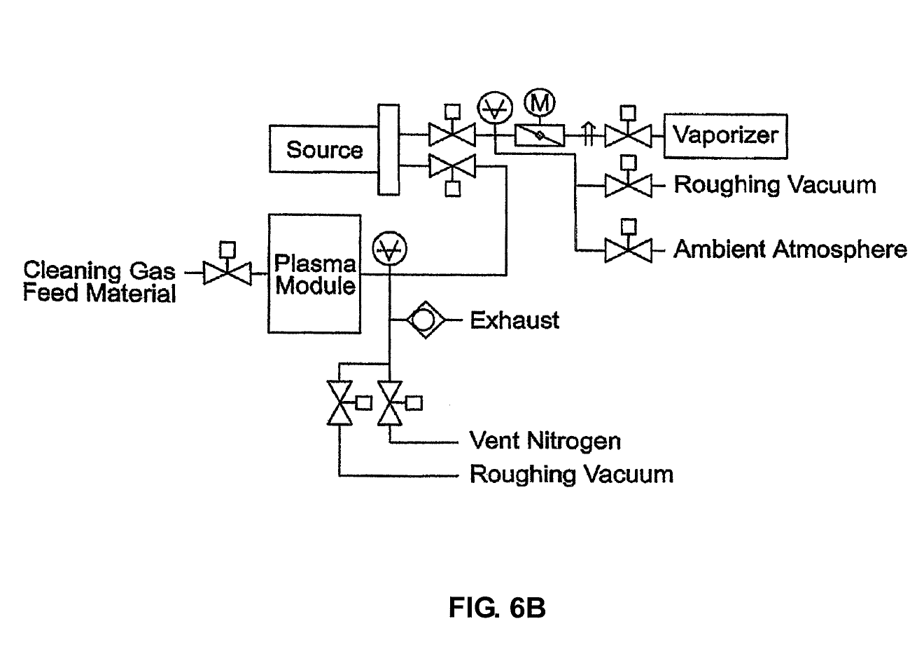

FIG. 4 shows an implementation similar to FIG. 2 for conducting in-situ chemical cleaning of an source 400 and extraction electrode 405. Three inlet passages are integrated into ion source 400, respectively for reactive gas 430 from plasma source 455, feed gas 435 from one of a number of storage volumes 450 selected, and feed vapor 440 from vaporizer 445. Unlike FIG. 3, the embodiment of FIG. 4 has the plasma-based reactive gas source 455 at the high voltage of ion source 400. This enables the remote plasma source 455 to share control points of the ion source 400, and also enables the cleaning feed gas 465 and argon purge gas from storage 466 to be supplied from the ion source gas distribution box, which is at source potential, see also FIGS. 6 and 6A. Also shown is a different type of endpoint detector, namely a Fourier Transform Infrared (FTIR) optical spectrometer. This detector can function ex-situ (outside of the vacuum housing), through a quartz window. Instead, as shown in FIG. 4, an extractive type of FTIR spectrometer may be used, which directly samples the gas in the vacuum housing 410 during cleaning. Also a temperature sensor TD may sense the temperature of the de-energized ionization chamber by sensing a thermally isolated, representative region of the surface of the chamber. The sensor TD can monitor heat produced by the exothermic reaction of F with the contaminating deposit, to serve as an end-point detection.

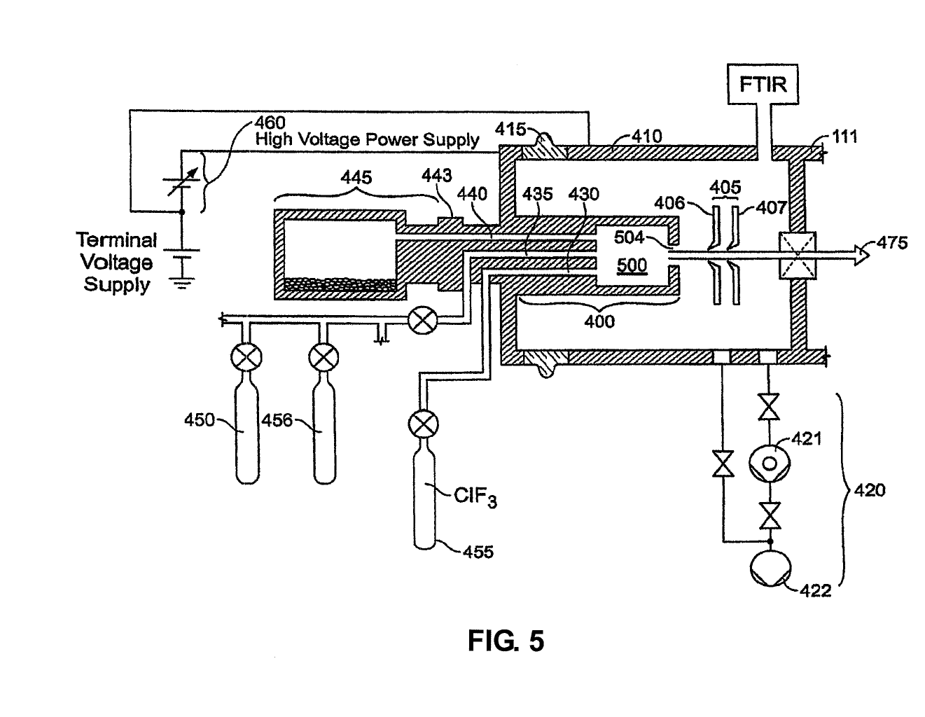

FIG. 5 shows an ion beam-generating system similar to that of FIG. 4, but incorporating a fundamentally different type of reactive gas source 455. In this case, reactive ClF.sub.3 gas contained in a gas cylinder is fed directly into ion source 400 without use of a remote plasma source. This potentially reduces equipment cost and footprint since power and controls for a remote plasma source are not required. However, since ClF.sub.3 is pyrophoric, it is dangerous and requires special gas handling, whereas NF.sub.3 (for example) is primarily an asphyxiant, and is less toxic than many semiconductor gases, such as BF.sub.3, PH.sub.3, or AsH.sub.3, and therefore safer.

FIG. 6 shows plasma source 455, vapor source 445, source electronics, and service facilities S for the plasma source contained within a gas box B meant for retrofit into an existing ion implanter installation.

The embodiment of FIG. 6a differs from the embodiment of FIG. 6 above, by incorporating a preferred vaporizer and flow control system described below. FIG. 6B is a valve schematic diagram for the ion source and self-cleaning system of FIG. 4.

### Exemplary Ion Source and Vaporizer

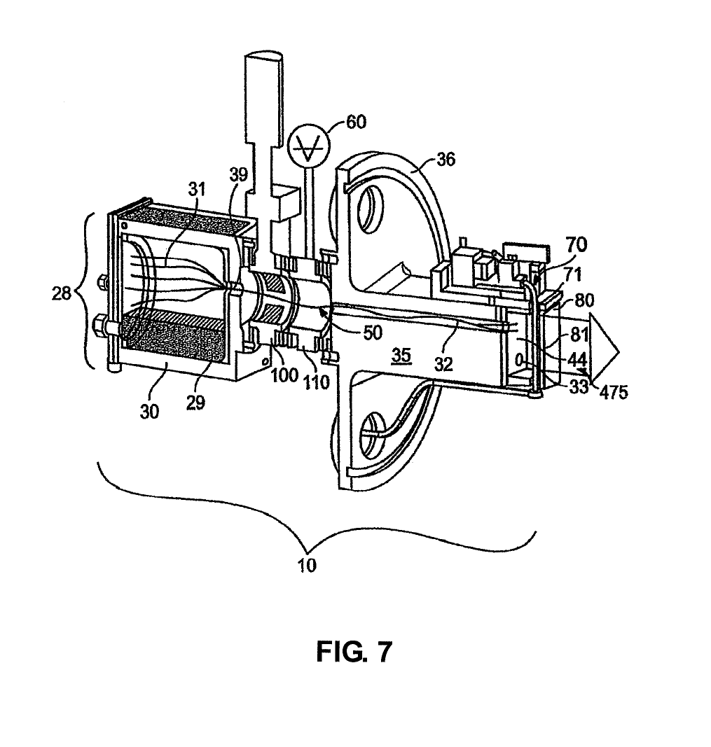

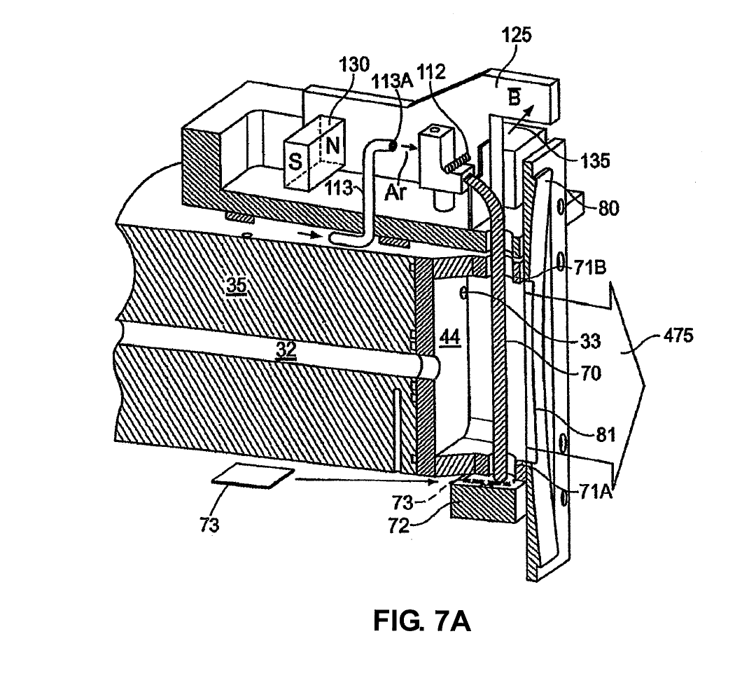

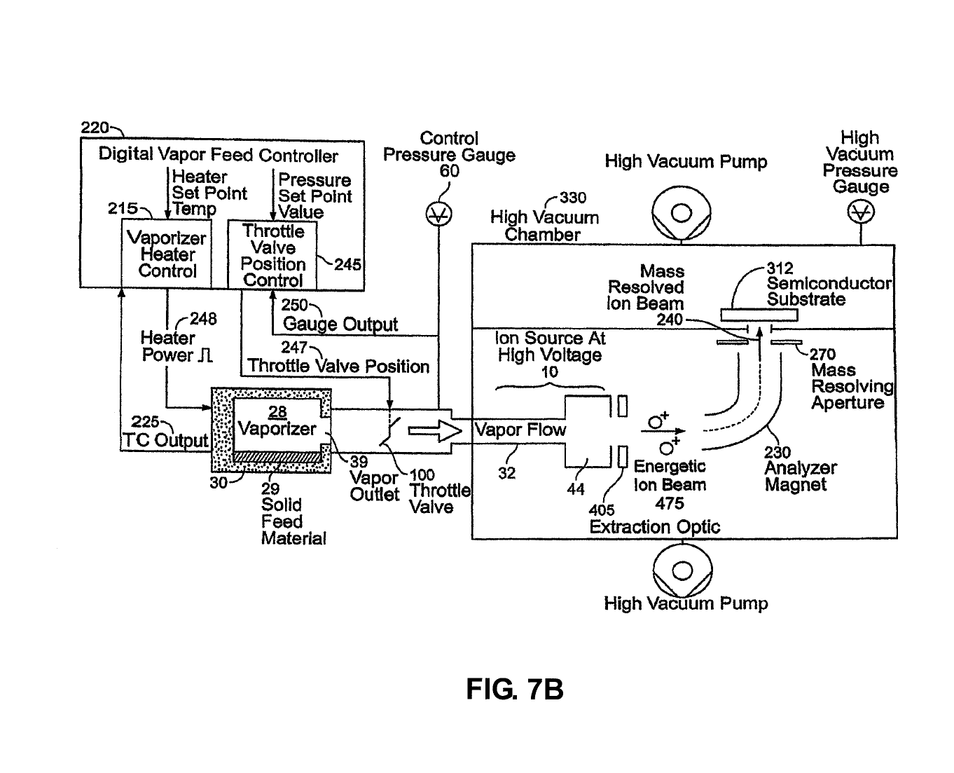

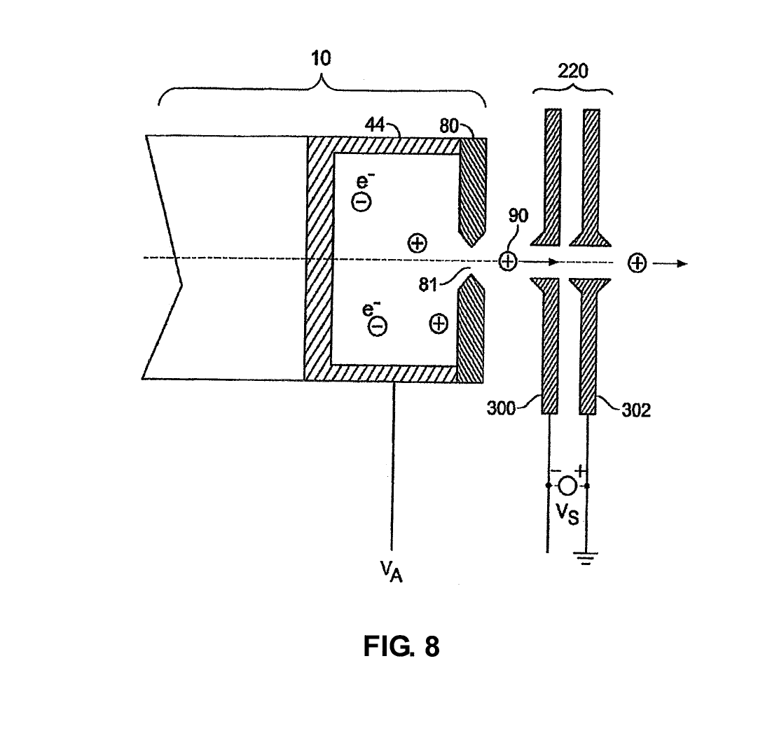

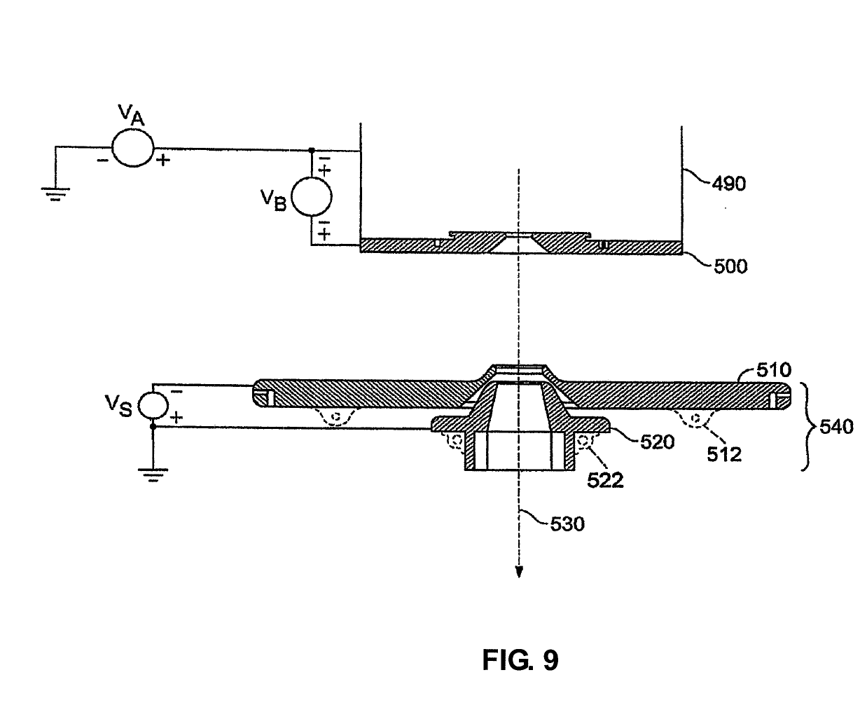

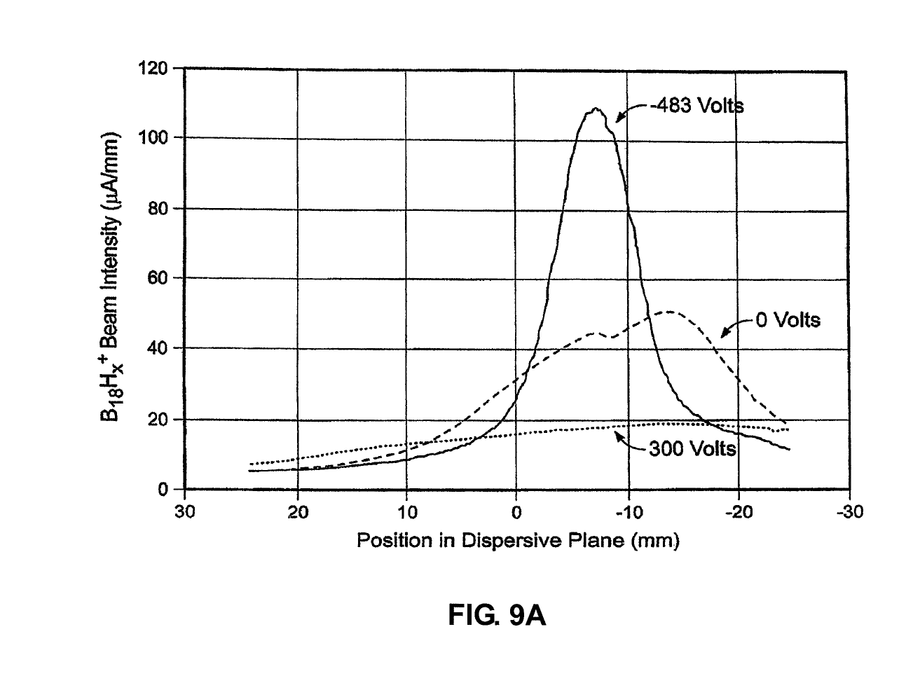

FIG. 7 is a diagram of an exemplary ion source 10 and its various components, and see FIG. 7A. The details of its construction, as well as its preferred modes of operation, are similar to that disclosed by Horsky et al., International Application No. PCT/US03/20197, filed Jun. 26, 2003: “An ion implantation device and a method of semiconductor manufacturing by the implantation of boron hydride cluster ions”, and by Horsky, U.S. patent application Ser. No. 10/183,768, “Electron impact ion source”, filed Jun. 26, 2002, both herein incorporated by reference. The ion source 10 is one embodiment of a novel electron impact ionization system. FIG. 7 is a cross-sectional schematic diagram of the source construction which serves to clarify the functionality of the components which make up the ion source 10. The ion source 10 is made to interface to an evacuated vacuum chamber of an ion implanter by way of a mounting flange 36. Thus, the portion of the ion source 10 to the right of flange 36, shown in FIG. 7, is at high vacuum (pressure <1.times.10⁻⁴ Torr). Gaseous material is introduced into ionization chamber 44 in which the gas molecules are ionized by electron impact from electron beam 70, which enters the ionization chamber 44 through electron entrance aperture 71 such that electron beam 70 is aligned with (i.e. extends adjacent, parallel to) ion extraction aperture 81. Thus, ions are created adjacent to the ion extraction aperture 81, which appears as a slot in the ion extraction aperture plate 80. The ions are then extracted and formed into an energetic ion beam 475 by an extraction electrode 220 (FIGS. 8 and 9) located in front of the ion extraction aperture plate 80. Referring to FIG. 7, gases such as argon, phosphine, or arsine, for example, may be fed into the ionization chamber 44 via a gas conduit 33. Solid feed materials 29 such as decaborane or octadecaborane can be vaporized in vaporizer 28, and the vapor fed into the ionization chamber 44 through vapor conduit 32 within the source block 35. Typically, ionization chamber 44, ion extraction aperture plate 80, source block 35 (including vapor conduit 32), and vaporizer housing 30 are all fabricated of aluminum. Solid feed material 29 is held at a uniform temperature by closed-loop temperature control of the vaporizer housing 30. Sublimated vapor 50 which accumulates in a ballast volume 31 feeds through conduit 39 and through throttling valve 100 and shutoff valve 110. The nominal pressure of vapor 50 between throttling valve 100 and shutoff valve 110 is monitored by heated pressure gauge 60, preferably a capacitance manometer. Since the vapor 50 feeds into the ionization chamber 44 through the vapor conduit 32, located in the source block 35, and gases feed in through gas conduit 33, both gaseous and vaporized materials may be ionized by this ion source, which is capable of creating ion beam 475 consisting of either molecular ions (such as B₁₈Hₓ⁺ or monomer ions (such as As⁺), as needed.

### Vapor Flow Control into the Ion Generating System

The flow of vapor to ionization chamber of FIG. 7, and see FIG. 7B, is determined by the vapor pressure in the region just before vapor feed passage 32, i.e., within shutoff valve 110 in FIG. 7. This is measured by pressure gauge 60, e.g. a capacitance manometer, located between throttling valve 100 and shut-off valve 110. In general, the flow rate is proportional to the vapor pressure. This allows the pressure signal to represent flow, and to be used as a set point to select flow. To generate a desired vapor flow into the ion source, vaporizer housing 30 is brought to a temperature such that when throttling valve 100 is in its fully open position, the desired flow rate is exceeded. Then the throttling valve 100 is adjusted to reach the desired pressure output.

To establish a stable flow over time, separate closed loop control of the vaporizer temperature and vapor pressure is implemented using dual PID controllers, such as the Omron E5CK control loop digital controller. The control (feedback) variables are thermocouple output for temperature, and gauge output for pressure. The diagram of FIG. 7B shows a digital vapor feed controller 220 for performing these closed loop control functions.

In FIG. 7B gauge output 250 from pressure gauge 60 is applied to throttle valve position control 245 which applies throttle valve position control signal 247 to throttle valve 100. Thermocouple output 225 from vaporizer 28 is applied to vaporizer heater control 215 which controls heater power 248 applied to the vaporizer 28.

A second, slow level of control is implemented by digital feed controller 220, accommodating the rate at which solid feed material vaporizes being a function of its open surface area, particularly the available surface area at the solid-vacuum interface. As feed material within the vaporizer is consumed over time, this available surface area steadily decreases until the evolution rate of vapors cannot support the desired vapor flow rate, resulting in a decrease in the vapor pressure upstream of the throttle valve 100. This is known as “evolution rate limited” operation. So, with a fresh charge of feed material in the vaporizer, a vaporizer temperature of, say, 25 C might support the required vapor flow at a nominal throttle valve position at the low end of its dynamic range (i.e., the throttling valve only partially open). Over time (for example, after 20% of the feed material is consumed), the valve position would open further and further to maintain the desired flow. When the throttle valve is near the high conductance limit of its dynamic range (i.e., mostly open), this valve position is sensed by the controller 220, which sends a new, higher heater set point temperature to the vaporizer heater control 215. The increment is selected to restore, once the vaporizer temperature settles to its new value, the nominal throttle valve operating point near the low end of its dynamic range. Thus, the ability of the digital controller 220 to accommodate both short-timescale changes in set point vapor pressure and long-timescale changes in vaporizer temperature makes the control of vapor flow over the lifetime of the feed material charge very robust. Such control prevents over-feeding of vapor to the ionization chamber. This has the effect of limiting the amount of unwanted deposits on surfaces of the ion generating system, thus extending the ion source life between cleanings.

FIG. 8 shows a top view (looking down) of an ion extraction electrode 220 facing the ion source 10. The ion source 10 is held at a positive potential V.sub.A with respect to the ion extraction electrode 220, which is at local ground potential, i.e., at the potential of the vacuum housing. The ion extraction electrode 220 is a simple diode; electrode plate 302 is the “ground” electrode and plate 300 the “suppression” electrode, typically held a few thousand volts below ground potential by suppression power supply V.sub.S. The ionization chamber 44 and ion extraction aperture plate 80 of ion source 10 are shown facing extraction electrode 220. The three plates 80, 300, 302 contain rectangular slots or apertures through which ions 90 are extracted; FIG. 8 illustrates the slot profiles in the “short”, or dispersive, direction.

### Heated Electrode

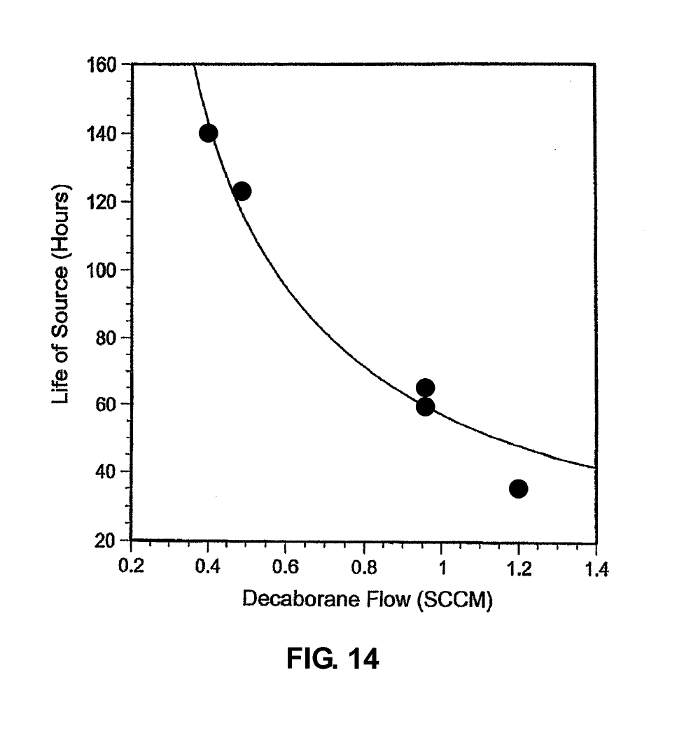

During the decaborane lifetime tests shown in FIG. 14, a heated aluminum electrode was used. FIG. 9 shows a top view of the basic optical design of the extraction system, in the dispersive plane of the one-dimensional “slot” aperture lenses. In the implanter used, the ionization chamber 490 of the ion source was held at the desired ion beam energy by positive high voltage power supply V_{A}, FIG. 8. For example, if a 20 keV ion beam is desired, then V_{A}=20 kV. Ion extraction aperture plate 500 is electrically isolated from ionization chamber 490 such that it can be biased by bipolar power supply V_{B} from −750V-750V. The isolation is accomplished by a thermally conductive, electrically insulating polymeric gasket which is sandwiched between the ion extraction aperture plate 500 and ionization chamber 490. The parts of the ion source body that are exposed to vapor (source block 35, ionization chamber 44, and extraction aperture plate 80 in FIG. 7) are maintained in good thermal contact with each other to maintain controlled temperature surfaces during source operation. Ions produced in ionization chamber 490 are extracted through the aperture in ion extraction aperture plate 500 by extraction electrode 540 consisting of suppression electrode 510 and ground electrode 520. The ions propagate as a focused ion beam along the beam axis 530. Suppression electrode 510, biased to a few thousand volts negative by power supply V_{S}, serves to suppress secondary electrons which are generated upstream from the suppression electrode due to beam strike, preventing these energetic electrons from backstreaming into the positively-biased ion source. The ionization chamber 490, ion extraction aperture plate 500, suppression electrode 510, and ground electrode 520 are all fabricated of aluminum, and have smooth, carefully polished surfaces to minimize local electric fields.

An important effect of biasing ion extraction aperture plate 500 is to change the focal length of the ion optical system of FIG. 9. A negative bias increases the focal length, while a positive bias decreases the focal length. For large biases, the effect can be substantial. For diagnostic purposes, a scanning-wire profilometer was installed, located at the entrance to the analyzer magnet, just downstream of the source housing isolation valve (210 in FIG. 16). This scanner recorded the beam current distribution in the dispersive plane, useful to determine how well the ion beam is being focused in the dispersive plane. 20 keV octadecaborane beam profiles are shown in FIG. 9a for three different biasing conditions: −483V, 0, and +300V. The zero volt condition is substantially overfocused, the positive voltage condition more overfocused, and the negative voltage condition properly focused. The electrode position was held constant during the three measurements. As expected, the proper focusing condition yielded the highest ion beam currents.

The ability to change the optical focal length, and thus tune the optical system to obtain the highest ion beam current, enables introduction of the least amount of feed material to the vaporizer. Again, this has the beneficial effect of limiting the amount of unwanted deposits on surfaces of the ion generating system, extending the ion source life between cleanings.

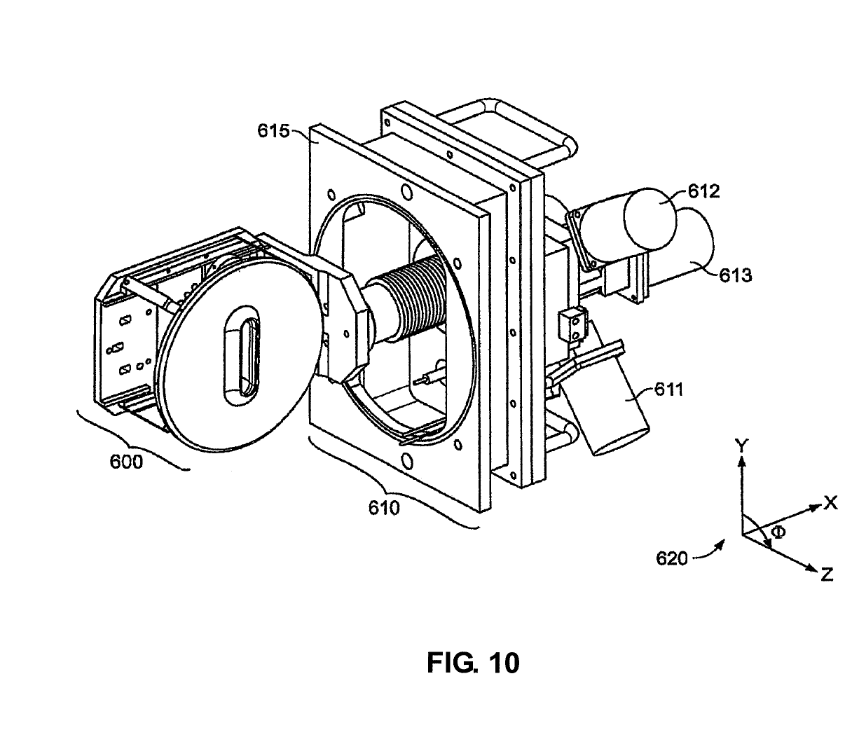

Besides the biasing of the extraction aperture plate for focusing the system just described, the invention provides means for moving the extraction electrode optic element relative to other components of the system. FIG. 10 shows the novel electrode 600 mounted on a three-axis manipulator 610 which allows for motion (with respect to the ion source) in X, Z and E), as defined by coordinate system 620. Actuator 613 controls X-motion, actuator 612 controls Z-motion, and actuator 611 controls E)-motion. The manipulator 610 mounts to the side of the implanter vacuum housing via mounting flange 615.

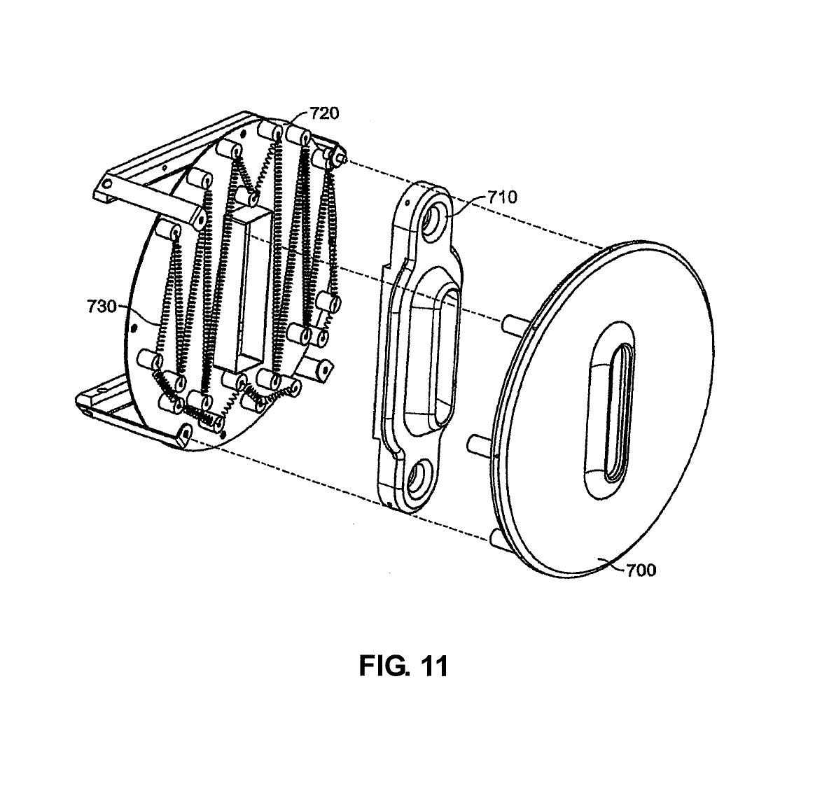

FIG. 11 shows a partial exploded view of the radiatively-heated version of the novel electrode head. Shown are suppression electrode 700, ground electrode 710, heater plate 720, and radiant heater wire 730. The suppression and ground electrodes are fabricated of aluminum, the heater plate of stainless steel, and the heater wire 730 of nichrome. When the electrode was operated at 200 C, power consumption was about 60 W to maintain the temperature. The heater power is controlled with a closed-loop PID controller, the Omron E5CK, based on readback of a thermocouple.

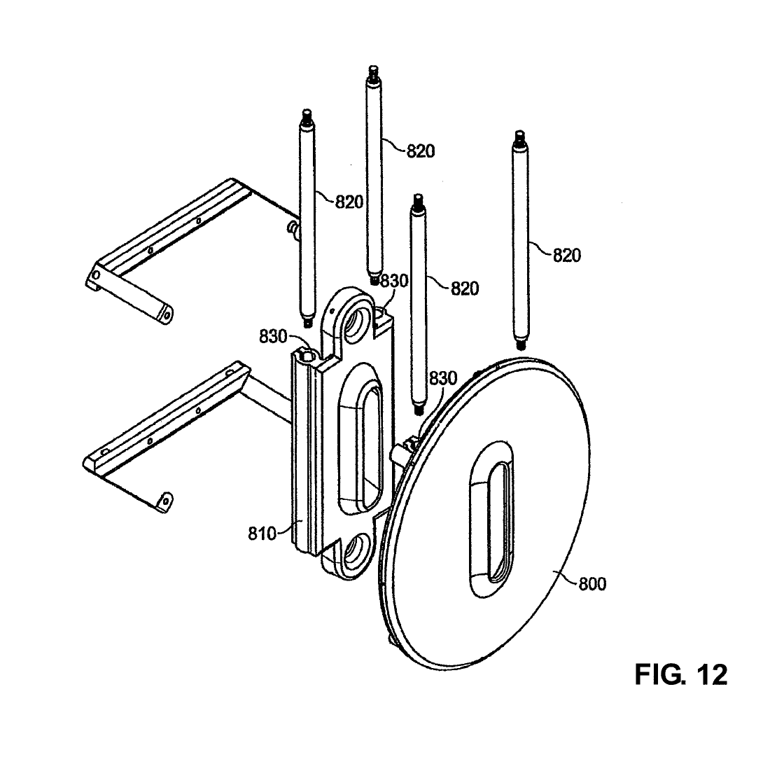

FIG. 12 shows a partial exploded view of a resistively-heated version of the novel electrode head. Shown are suppression electrode 800, ground electrode 810, and resistive heaters 820. The four resistive heaters 820 fit into sleeves 830, two into each electrode plate. The sleeves 830 are a split design such that the heater press-fits into the sleeve, achieving intimate contact. Intimate contact between heater and electrode is important to insure proper heating of the electrode, and to prevent premature burnout of the heaters. Again, the Omron E5CK or equivalent can control the electrode temperature based on readback of a thermocouple.

As described above, use of these heating arrangements for the extraction electrode maintain a well-controlled, elevated temperature sufficiently high to prevent condensation of decaborane and octadecaborane such as produced by the relatively cool-operating ion source of FIGS. 7 and 7A. The extraction electrode made of fluorine-resistant materials, e.g. aluminum, enables periodic in situ cleaning of the electrode to remove any deposits by fluorine vapors drawn through the extraction aperture.

A different situation is encountered with plasma ion sources that inherently run so hot that the heat may harm the extraction electrode assembly if made of low temperature material. Referring to FIG. 9, shown in dotted lines are circular cooling coils, 512 and 522 secured in heat transfer relationship to the backs of aluminum electrode members 510 and 522, respectively. Circulation of cooling fluid through these cooling coils can cool the aluminum electrodes to prevent deformation by heat from hot ion sources. This enables use of fluorine-resistant materials for the extraction electrode, for instance aluminum or a complex containing aluminum, which provide resistance to attack by any fluorine present from feed materials or from reactive cleaning gas.

### Source Lifetime Measurements when Running Decaborane

FIG. 14 shows the results of source lifetime testing over a broad range of decaborane flows. The fit to these data is from Equation (3). No failures of the ion source were recorded during these tests; rather, the individual tests were ended when the decaborane ion current dropped to roughly half of its initial level. Upon inspecting the ion source, it was found that a substantial amount of boron-containing material was deposited within the ionization chamber, mostly adhering to the interior walls of the chamber. In some cases, the ion extraction aperture was also partially occluded. The model of Equation (3) seems to fit the data well, and suggests that “lean” operation is the key to prolonged ion source lifetime, between in situ chemical cleaning procedures or disassembly.

### Measurements of Etch Rates within Ionization Chamber During F Cleaning

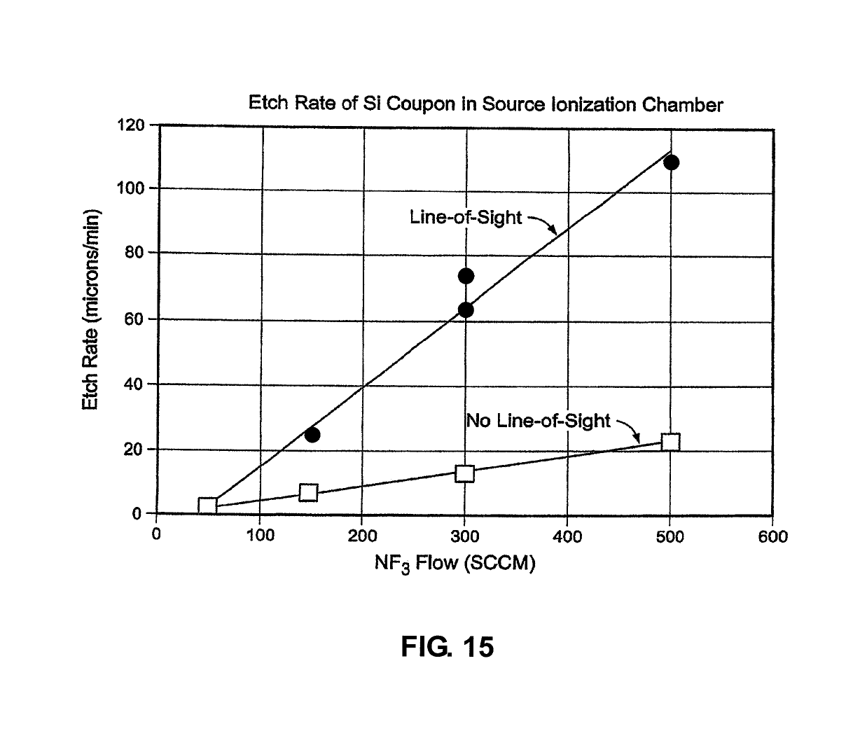

The system with the ion source 10 of FIG. 7 was used to test the F cleaning process, although Cl or other reactive cleaning or etch agents may be used, on 1-mm-thick silicon coupons staged inside of the ionization chamber 44, with the following modification: rather than incorporating a dedicated reactive feed conduit, the vapor feed conduit 32 was employed to introduce the reactive gas. Si was used because etching of Si by F is well understood, and pure Si material is available in the form of Si wafers. This test required removing the vaporizer between cleaning cycles. Two coupon locations were tested: one having line-of-sight relationship with the reactive gas inlet (i.e., the vapor feed 32), and one not having line-of-sight. The etch rates are shown in FIG. 15 as a function of NF.sub.3 flow rate. During this process, a flow of 700 sccm of argon was maintained into the remote plasma source while the NF.sub.3 flow rate was varied from 50 sccm to 500 sccm. A line-of-sight geometry shows a factor of about five increase in etch rate, and is therefore a preferred geometry if it can be done uniformly. To this end, the geometry portrayed in FIG. 3 should provide better etch uniformity of the ion source ionization chamber 44 than the geometry shown in FIG. 4. The test also indicated that location of etch-sensitive components shielded from the gas flow is effective to provide a degree of protection to those components.

To extend the life of components of the self-cleaning ion generating system construction materials are selected that are resistive to the reactive gas, and provision can be made for shielding of sensitive components.

For the interior of the ionization chamber, as indicated above, aluminum is employed where the temperature of the ionizing action permits because aluminum components can withstand the reactive gas fluorine. Where higher temperature ionizing operation is desired, an aluminum-silicon carbide (AlSiC) alloy is a good choice for the surfaces of the ionization chamber or for the extraction electrode. Other materials for surfaces in the ionization chamber are titanium boride (TiB₂), Boron Carbide (B₄C) and silicon carbide (SiC).

For components exposed to the fluorine but not exposed to the ionizing action, for instance electron source components such as electrodes, the components may be fabricated of Hastelloy, fluorine-resistant stainless steels and nickel plated metals, for instance nickel-plated molybdenum.

Both inert gas shields and movable physical barriers can protect components of the system from the reactive gas during cleaning. For example, referring to FIG. 7A, a conduit 113 for inert gas, for instance argon, extends from a gas source, not shown. Its outlet is at a strategic location in the ion source, such that flow of the inert gas, when initiated for the cleaning cycle, floods the component to be protected. In FIG. 7A the outlet 113a of inert gas conduit 113 aims a flooding stream of argon over the active components of electron gun 112, including, the electron-emitting cathode. In FIG. 7A a movable shield member 73 is also shown, which is movable into position for the cleaning cycle. In the example shown, it is movable over the aperture 71A leading to beam dump 72, or to another electron gun when provided on that side of the ionization chamber 44.

The cleaning process described above was conducted to observe its effect on boron deposits within the ionization chamber and on the interior of the ion extraction aperture of the novel ion source 10 of FIG. 7. The observed etch rates had characteristics similar to the plot of FIG. 15, but were a factor of 3 lower. Thus, for a NF.sub.3 flow rate of 500 sccm, the etch rate for decaborane deposits were 7 μm/min (no line-of-sight), and 36 μm/min (line-of-sight). The interior of the ion extraction aperture after running 4 hrs of decaborane at 0.8 sccm vapor flow had about 133 μm thick boron-containing deposit prior to cleaning. Observations were made after a 5 min F clean, and after a 15 min F clean using these flow rates. One side of the aperture plate was in line-of-sight with the vapor feed. It was observed from the cleaning pattern that the vapor feed aperture is centered in the vertical direction! After 15 minutes of cleaning, the plate was almost completely free of deposits. Also, the novel heated aluminum ion extraction electrode of FIG. 10 was removed and inspected after long operation. It was very clean with no observable decaborane deposits. This was undoubtedly due to exposure of the electrode to reactive F (F can flow through the ion source ion extraction aperture located in front of the vapor conduit, to the extraction electrode directly in front of it). Also, elevated temperature of the Al electrode assembly increased the effective etch rate of its deposits.

With respect to the ionization chamber, again, a 15 min etch clean left the chamber nearly free of deposits. A test was conducted in which the system was repeatedly cycled in the following manner: two hours of decaborane operation (>500.mu.A of analyzed beam current), the source was turned off and the filament allowed to cool, followed by a 15 min chemical clean at 500 sccm of NF₃ feed gas and 700 sccm of Ar, to see if conducting repeated chemical cleaning steps was injurious to the ion source or extraction electrode in any way. After 21 cycles there was no measurable change in the operating characteristics of the ion source or the electrode. This result demonstrates that this F cleaning process enables very long lifetime in ion source operation of condensable species.

### The Ion Generating System Incorporated into an Exemplary Ion Implanter

FIG. 16 shows the basic elements of a commercial ion implanter, with an embodiment of the novel ion beam generation system incorporating the ion source of FIG. 7 installed. The ion source 10 is inserted into the source vacuum housing 209 of the ion implanter. It is electrically insulated from housing 209 by insulator 211. The ion extraction electrode 220 extracts and accelerates ions from the ion source 10 to form an ion beam 200. Ion beam 200 propagates entirely in vacuum; from the electrode 220 it enters analyzer housing 290, 300 where it is bent and dispersed by dipole analyzer magnet 230 into separate beamlets which differ by their charge-to-mass ratio. The ion beamlet of interest passes through mass resolving aperture 270 and into a final acceleration (or deceleration) stage 310. The thus-produced, -selected and -accelerated ion beam 240 leaves the ion beam forming system 208 and is introduced to the process chamber 330 where it intercepts one or more device wafers 312 on rotating disk 314. The ion source vacuum housing 209 can be isolated from the remainder of the implanter's vacuum system by closing isolation valve 210. For example, isolation valve 210 is closed prior to in situ cleaning of the ion source.

### Improved Efficiency Cleaning System for Semiconductor Processing Systems

FIGS. 17-22 relate to an alternate embodiment of an in situ cleaning system for an ion source, such as the ion sources disclosed in FIGS. 1-6 and described above, which provides improved efficiency over known cleaning systems by means of a dynamic process of cyclic control of various parameters of the cleaning gas, including, pressure, gas flow, time and rate of change. As will be discussed in more detail below, in one embodiment of the invention, the pressure of the cleaning gas i.e reactive gas, such as NF₃, is varied with respect to time during a cleaning cycle in order to create pressure gradients which improve the efficiency of the cleaning cycle. In accordance with the present invention, the pressure gradients can be created by varying one or more cleaning parameters, such as varying the flow rate of cleaning gas; and varying the speed of the roughing pump 422; as well as controlling the control valves, e.g. control valves 920, 930 and 940, in fluid communication with the roughing pump 422 to vary the flow rate of the roughing pump 422.

The present invention is thus able to solve the problems associated with known in situ cleaning systems. More particularly, in some known systems, the pressure of the cleaning gas in the ion source or system to be cleaned is maintained at a relatively constant or static value. In such systems, the static pressure of the cleaning gas results in relatively limited efficiency of a cleaning cycle. In particular, in such systems, the problem is that the reactants in the cleaning gases have a limited lifetime. Therefore, sustaining a constant pressure of the cleaning gas in the system during an entire cleaning operation may not be effective. In order to address this problem, cleaning systems have been developed in which the flow rate of the cleaning gas is maintained constant to the system to be cleaned. Although such systems are able to provide the necessary replacement of the reactants and improve the overall efficiency of the cleaning cycle there are other problems with such systems. More particularly, in systems in which a constant flow rate of the cleaning gas is maintained, the concentration of the reactants in the cleaning gas is not uniformly distributed throughout the system to be cleaned and is a function of the gas dynamics of the introduction system, which is highly directional. Thus, in certain locations in the system to be cleaned, where concentrations are relatively low, there is insufficient replenishment of the reactants in the steady state, which reduces the overall cleaning efficiency of the cleaning cycle.

In accordance with an important aspect of the invention, a dynamic process is used in which the cleaning gas pressure, gas flow, cycle time or combinations thereof are varied by, e.g., repeatedly filling and venting the system to be cleaned with different pressures, flow rates or cycle times or variations thereof. As such, each time the system is vented and re-filled, reacted products are removed and new reactant material is introduced into the system to replace the reacted products, thereby improving the effective reaction rate and efficiency of a cleaning cycle.

More particularly, in one embodiment of the cleaning system in accordance with the present invention, the system to be cleaned is repeatedly subjected to various pressure cycles of the cleaning gas, during a cleaning cycle, for example, as illustrated in FIGS. 17, 18 and 22. An exemplary pressure cycle is illustrated in FIG. 17 and generally identified with the reference numeral 900. These pressure cycles may be periodic or non-periodic. Also the characteristics of the pressure cycles can also vary during a single cleaning cycle. As shown in FIG. 17, the pressure cycle 900 includes a fill portion 902, a dwell portion 904 and a vent portion 906. As shown, the pressure of the cleaning gas is forced to vary from a first pressure, for example, a low pressure P_{MIN} during the fill portion, to a second pressure, for example, a higher pressure P_{MAX}, and back to a third lower pressure, which may be P_{MIN} or a lower or higher pressure than P_{MIN}.

As shown in FIG. 17, the fill portion 902 varies linearly or at a constant rate from P_{MIN} to P_{MAX} during a time period t_{FILL}. Other functions of pressure with respect to time are also considered to be within the broad scope of the invention. In practice, the fill cycle looks more like (1−exp[P/P0]); i.e., it starts out linear but as the pressure approaches P_{MAX}, pumping speed exactly compensates flow rate of new material, so P approaches P_{MAX} asymptotically (see FIG. 22). Accordingly, we have found that one might want to vary flow rate during this part of the cycle, to make it converge to Pmax faster.

For example, during the fill portion of the pressure cycle, the pressure can be varied non-linearly with respect to time, for example, as illustrated by the waveforms in FIGS. 18 and 22. Once the pressure of the cleaning gas reaches P_{MAX}, the fill portion 902 of the pressure cycle 900 is considered complete. The cleaning gas may be maintained at P_{MAX} for a dwell time t_{DWELL}. When the dwell time t_{DWELL} has elapsed, the cleaning gas is vented from the system to be cleaned during the vent portion 906 of the pressure cycle 900. As shown, the cleaning gas is vented by lowering the pressure from P_{MAX} to P_{MIN} during a time period t_{VENT}. Similar to the fill portion, the pressure of the cleaning gas can be reduced non-linearly. Moreover. the pressure during the vent portion 906 can be reduced to a pressure either higher or lower than P_{MIN} and adjusted to P_{MIN} prior to the next pressure cycle, if necessary, depending on the characteristics of the next pressure cycle.

As shown in FIG. 17, the fill time t_{FILL}+ the dwell time t_{DWELL}+ the vent time t_{VENT} of this pressure cycle embodiment=t_{MAX}. As shown, the length of the fill time t_{FILL} is shown to be different from the length of the vent time t_{VENT}. The principles of the present invention also include embodiments in which the length of the fill time t_{FILL} is the same as the length of the vent time t_{VENT}. More specifically, the principles of the invention include variations of time, pressure, flow rate and combinations thereof to optimize the reaction kinetics of the cleaning process.

Various considerations are necessary in order to optimize the various parameters involved in a pressure cycle 900. With respect to the parameter P_{MAX}, higher pressure results in a higher active concentration which depletes more of the deposit resulting from the source feed gas ion operation, e.g. Boron, if a Boron feed gas is used, on the surfaces of the ion source, per unit of time until all surfaces of the ion source have reacted with the cleaning gas. On the other hand, excessive pressure can result in recombination of the reactant, i.e. F, thus reducing the active concentration of the reactant.

Reaction kinetics are believed to be governed by the film mass transfer resistance at the solid-gas interface. Thus, the influence of the parameter P_{MAX} can be predicted by the empirical reaction rate equation, shown below, which is based on units of an exposed surface.

$$- \frac{1}{{S}_{ex}} \frac{d {N}_{A}}{d t} = {k}_{g} ( {C}_{Ag} - {C}_{Ae} )$$

where K_{g} is the mass transfer co-efficient between the solid and the gas;
C_{Ag} is the concentration of A in the gas phase;
C_{Ae} is the equilibrium concentration of A on the surface; and

$${C}_{Ag} = \frac{{p}_{Ag}}{RT}$$

As shown above, C_{Ag} is directly proportional to the pressure of A in the gas phase. The empirical equation above suggests that increasing the pressure of the cleaning gas increases the reaction rate. However, the pressure of the cleaning gas can also result in an undesirable recombination of the reactants, that is, e.g., activated atomic fluorine, F*, which is highly reactive, can decay into F or even combine into F₂, depending on peak concentration. If the peak concentration is too high, F* can recombine before it reacts with the deposits. However, if the peak concentration is too low, then the reduced concentration of F* reduces the reaction rate and overall etch rate.

The minimum pressure P_{MIN} is selected to evacuate the reaction products from the system to be cleaned. More particularly, the minimum pressure P_{MIN} is selected to provide adequate cycle and dilution, that is, if it takes too long to reach P_{MIN} it un-necessarily extends the cycle whereas, if P_{MIN} is too high, not enough replacement of the reactants occur. We have found that a desired ration of P_{MAX} to P_{MIN} is, 5≦P_{MAX}/P_{MIN}≦10. In the embodiment shown in FIG. 22, P_{MIN}=1 Torr, P_{MAX}=8 Torr and t_{MAX}=90 seconds.

In accordance with the present invention, the dwell time t_{DWELL} may also be optimized. Short dwell times t_{DWELL} are generally wasteful of the activated reactants, i.e. F and therefore reduce the percentage of the duty cycle where efficient cleaning is accomplished because of the fixed fill times t_{FILL} and the fixed vent times t_{VENT}. The duty cycle refers to that portion of the pressure cycle in which the pressure is at P_{MAX}. Relatively long dwell times allow all available reactants to generate the desired end products. Based upon the empirical equation above, the dwell time t_{DWELL} is selected in part based upon the reaction rate, which, is based upon the maximum pas pressure P_{MAX}. On the other hand, excessively long dwell times t_{DWELL} do not provide an additional benefit and only extend the cleaning time. Thus, the dwell time t_{DWELL} is optimized by selecting a duty cycle that optimizes the reaction rate.

In one embodiment of the invention, the cleaning cycle may be optimized by optimizing T_{MAX} separately from the dwell time t_{DWELL}. More particularly, the dwell time t_{DWEL} is selected based upon the maximum pressure P_{MAX} selected. As discussed above, the reaction rate of the cleaning gas is based upon the maximum pressure P_{MAX} of the cleaning gas. Thus, the dwell time t_{DWELL} will vary depending on the maximum pressure P_{MAX} selected. For example, when relatively low maximum gas pressures P_{MAX} are used, longer dwell times t_{DWELL} may be used. Conversely, shorter dwell times t_{DWELL} may be used with relative high maximum gas pressures P_{MAX} are used.

The maximum time t_{MAX} may be optimized separately. As discussed above, the maximum time t_{MAX} is the sum of the dwell time t_{DWELL}+ the fill time t_{FILL}+ the vent time t_{VENT}. As shown in FIG. 17, the fill time t_{FILL} is relatively longer than the vent time t_{VENT}. The shorter vent time t_{VENT} gets rid of the reaction products relatively quickly from the system and thereby allow replacement reactants to quickly enter, for example, as illustrated in FIG. 22.

One embodiment of the invention is illustrated in FIGS. 21a-21c. In particular, FIG. 21a illustrates a pressure cycle that is responsive to the pumping speed of the roughing pump 422, as illustrated in FIG. 21b, and an associated cleaning gas flow rate, as illustrated in FIG. 21c. As shown in FIGS. 21a-21c, during the Fill portion of the pressure cycle, the cleaning gas pressure increases at a constant rate, for example, by way of the control valve 910, as discussed below, while the pumping speed of the roughing pump 422 is maintained at a constant first level, illustrated in FIG. 21b as a relatively low value. During the Fill portion of the pressure cycle, the cleaning gas flow is maintained at a first high level, for example by way of the control valve 910. Upon reaching the maximum pressure level for this embodiment, i.e. dwell portion, the pressure is held high during the Dwell period, the roughing pump 422 maintains the first pumping speed, and the flow rate is reduced to a second level, for example, a relatively low level in this instance, for example, by way of the control valve 910. Upon initiation of the Vent portion of the pressure cycle, the flow rate is maintained constant at the second level, low, for example, by way of the control valve 910, whereas the pumping speed of the roughing pump 422 is raised to a second level, high, thereby reducing the cleaning gas pressure at a non linear rate. By controlling the speed of the roughing pump 422 or cleaning gas flow rate and associated pressure levels, the Fill and Vent times of a pressure cycle can be controlled.

Various methods can be used to control the pressure of the cleaning gas, as discussed above. For example, the system illustrated in FIG. 3, can be slightly modified to incorporate a valve 910 between the reactive gas source 455 and the ionization chamber 500. The valve 910 can be used to maintain a constant flow rate of the cleaning gas to enable the pressure of the cleaning gas to buildup in the ionization chamber 500. Alternatively, the valve 910 can be a variable flow control valve to vary the flow rate of the cleaning gas. The roughing pump 422 may be used to cycle the pressure of the cleaning gas within the semiconductor processing system, for example, from 1 to 8 Torr in 50 second increments, for example, as illustrated in FIG. 18. More particularly, the roughing pump 422 is used to pull down the pressure of the cleaning gas at a faster rate than the buildup. Alternatively, the roughing pump 422 can be cycled to raise the pressure of the cleaning gas from 2.5-5.5 Torr in 10 second increments.

Alternately, a bypass valve around the high vacuum pump 421 can be replaced with a variable flow control valve 920. The variable flow control valve 920 can be controlled to vary the pressure of the cleaning gas. More particularly, the roughing pump 422 is used to pull down the pressure of the cleaning gas. Thus, during a “fill” portion of the pressure cycle, the valve 920 may be closed or partially closed to allow the pressure of the cleaning gas to build up from P_{MIN} to P_{MAX}. When the pressure of the cleaning gas reaches P_{MAX}, the valve 920 is controlled to regulate the pressure of the cleaning gas at P_{MAX} for the required dwell time t_{DWELL}. At the expiration of the dwell time t_{DWELL}, the valve 920 is opened to draw down the pressure of the cleaning gas to P_{MIN} or another pressure lower than P_{MAX} to allow the reaction products to vent completing a pressure cycle. The pressure cycle is then repeated until the cleaning process reaches a desired endpoint, as discussed above.

In another embodiment of the invention, the variable flow control valve 920 can be replaced with a pair of parallel control valves 930 and 940, as illustrated in FIG. 20. In this embodiment, one valve 930 may include a small restriction such that the roughing pump 422 removes less gas. The second valve 940 is configured with a relatively larger opening (less restriction) so that the roughing pump 422 can pull down the pressure of the cleaning gas quickly. In operation, initially one or both of the valves 930 and 940 are controlled to enable a controlled buildup of the cleaning gas pressure from a minimum pressure P_{MIN} to a maximum pressure P_{MAX} during a “fill” portion of the pressure cycle. Once the pressure of the cleaning gas reaches the maximum pressure P_{MAX}, the valves 930 and 940 are controlled to maintain the pressure of the cleaning gas at the maximum pressure P_{MAX} for the desired dwell time t_{DWELL}. At the expiration of the desired dwell time t_{DWELL}, the valves 930 and 940 are controlled to pull down the pressure of the cleaning gas to P_{MIN} or other pressure lower than P_{MAX} during a “vent” portion of the pressure cycle.

Other embodiments of creating a pressure cycle of the cleaning gas include varying the frequency of the pressure change and varying all the above by means of the reactive gas inlet flow rate (instead of by means of the pump). The frequency of the pressure change may be varied by varying the fill time t_{FILL} and/or the vent time t_{VENT}, as discussed below.

There are various methods to control the fill time t_{FILL} and vent time t_{VENT}. These times are a function of one or more of the parameters associated with the system, such as, the pressure of the cleaning gas as it leaves the reactive gas source 455 and the characteristics of the roughing pump 422. These times will also depend on the use and the characteristics of any valves used in the system, such as the valves 910, 920, 930 and 940. One or more of these parameters may be manipulated to control the fill time t_{FILL} and/or the vent time t_{VENT}.

Obviously many modifications and variations of the present invention are possible in light of the above teachings. Thus, it is to be understood that, within the scope of the appended claims, the invention may be practiced otherwise than is specifically described above.

What is claimed and desired to be secured by a Letters Patent of the United States is:

1. A cleaning system for cleaning a semiconductor processing system comprising:
a reactive gas generator capable of disassociating a gaseous feed compound to provide reactive gas, the generator operable when the ion source is de-energized to provide a flow of reactive gas into and through said semiconductor processing system to be cleaned to react with and remove the deposits on at least some of the surfaces of the semiconductor processing system; and
a control system for varying the pressure of said reactive gas during a cleaning cycle.

2. A cleaning system for cleaning a semiconductor processing system comprising:
a cleaning gas supply to provide gas into said semiconductor processing system to be cleaned to react with and remove the deposits on at least some of the surfaces of the processing system; and
a control system for varying the cleaning gas parameters during a cleaning cycle.

3. A method of cleaning a semiconductor processing system comprising the steps of:
supplying a cleaning gas to the system;
increasing the flow rate of the cleaning gas supplied to the system during a first time period;
decreasing the flow rate of the cleaning gas supplied to the system during a subsequent time period;
repeating the steps of increasing and then decreasing the flow rate of the cleaning gas supplied to the system.
